(19) United States
(12) Patent Application Publication
(10) Pub. No.: US 2026/0011968 A1
(43) Pub. Date: Jan. 8, 2026

(54) SYSTEM AND METHOD FOR CRIMPED-WIRES INSERTION TO A CONNECTOR MACHINE

(71) Applicant: Frisimos, Ltd., Kadima Zoran (IL)

(72) Inventors: Tal Pechter, Ramat HaSharon (IL); Hanan Ben-Ron, Herzliya (IL); Kosta Pinchuk, Netanya (IL)

(73) Assignee: Frisimos, Ltd., Kadima Zoran (IL)

(21) Appl. No.: 19/125,001

(22) PCT Filed: Oct. 27, 2023
(86) PCT No.: PCT/IB2023/000646

§ 371 Date: Apr. 28, 2025

Related U.S. Application Data
(60) Provisional application No. 63/419,717, filed on Oct. 27, 2022.

(51) Int. Cl. H01R 43/052; H01R 43/055

(52) U.S. Cl. CPC H01R 43/052; H01R 43/055

(57) ABSTRACT

A system and method for automatically inserting crimp contacts of a plurality of wires into holes of a connector is disclosed. Each hole of a connector has an electrical contact surface that is for electrical/physical contact with a designated part of a crimp contact. Thus, for proper electrical/physical contact, the connector and/or the crimp contact may be rotated to prepare for insertion of the crimp contact. As such, prior to the insertion, the connector and/or the crimp contact is rotated in an automatic orientation movement. After which, the automatic insertion movement is performed in which the crimp contact and/or the connector are moved so that the designated part of the crimp contact is in electrical/physical contact with the electrical contact surface of the hole. The automatic insertion movement may include the crimp contact being stationary and the connector is moving, or the connector being stationary and tire crimp contact moving.

### REFERENCE TO RELATED APPLICATION

The present application claims priority to U.S. Provisional Application No. 63/419,717, filed on October 27. 2022, which is incorporated by reference herein in its entirety.

### TECHNICAL FIELD

The present disclosure generally relates to the cable and connector industry, and more particularly to inserting crimped wires into a connector machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Electronic devices may communicate with one another. Connectivity amongst the different electronic devices may be facilitated by using physical connectors (such as cables). The connectors may have various parameters such as: size, labeling, interface parameters, structure, etc. Interface parameters may include: number of connectivity pads (e.g., pins), the layout of the connectivity pads and their physical size, etc.

Further, there are many different types of connectors. Examples of different standard connector types include, but are not limited to: an eight position-eight conductor (8P8C) modular connector with eight positions, which may be used in Ethernet® communications; a D-subminiature electrical connector commonly used for the RS-232 serial port on: modems, computers, telecommunications, test and measurement instruments; an HDMI (High-Definition Multimedia Interface) connector compact audio/video interface for transferring uncompressed video data and compressed/uncompressed digital audio data from a HDMI-compliant device (“the source device”) to a compatible computer monitor, video projector, digital television, or digital audio device; a Universal Serial Bus (USB) connector (e.g., USB 2.0 has a 4-pin connector; USB 3.0 has 9 pins surrounded by a shield); a Power connector which may include a safety ground connection as well as the power conductors for different household equipment; a RF Connector used at radio frequencies having constant impedance of its transmission line; a R-TNC (Reverse threaded Neill-Concelman) connector used for Wi-Fi antennas; a BNC connector for used in radio and test equipment; DC connector which may supply direct current (DC) power; Hybrid connectors which may have housings with inserts that allow intermixing of many connector types, such as those mentioned above; optical fiber connectors; and many more different types of connectors.

Each field/system/device may have a standard or custom electrical cable that has different parameters. Example of electrical cable's parameters may include any one, any combination or all of: length; cable diameter; number of inner-wires; inner-wire coloring; inner-wire diameter; cable color; labeling; insulation/shielding; and winding/twisting.

One or more wires may have their isolation layer stripped at one end, thereby exposing the inner conductor (e.g., copper wiring). After which, a crimp contact may be crimped onto the exposed end. The end of the wire, with the crimped contact, may then be inserted into a connector. However, this process can be very labor-intensive.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 is an illustration of cables and wires on a pallet.

FIGS. 2A-B are example connectors including an M8 connector and M12 connector.

FIGS. 3A-D show orientations of the M12 Male connector (FIGS. 3A-B) and the M12 Female connector (FIGS. 3C-D).

FIGS. 4A-B show orientations of the M8 Male connector (FIG. 4A) and the M8 Female connector (FIG. 4B).

FIGS. 5A-D shows the terminal depth for the connectors, which may vary based on which connector (e.g., M8 connector versus M12 connector) or which may vary based on the pin within the connector (e.g., middle pin of a 5 pin connector is at a different depth, such as at a deeper depth, than the outer pins of the 5 pin connector), with FIG. 5A depicting M12 female connector. FIG. 5B depicting M12 male connector, FIG. 5C depicting M8 female connector, and FIG. 5D depicting M8 male connector.

FIG. 6A is an illustration of where the gripper(s) may hold the wires, such as holding on the wires and/or on the area connecting the wires to the crimp contact.

FIG. 6B is a side view of the wire of the cable after having been crimped with the crimp contact.

FIG. 7 is a block diagram of one example layout in which a crimped-wires insertion to connector machine may be placed within a plurality of other machines as part of a production line.

FIG. 8A illustrates an example initial state of the wires, with crimp contacts, placed on a comb.

FIGS. 8B-F illustrate a sequence of inserting. wire-by-wire, the wires (with crimp contacts) into the connector.

FIG. 9 is a perspective view of a first example of the crimped wire insertion machine.

FIG. 10A is a top view of a pallet holding both ends of the cable as it enters the station for the crimped wire insertion machine illustrated in FIG. 9.

FIG. 10B is a top view of a pallet holding both ends of the cable at the station for the crimped wire insertion machine illustrated in FIG. 9, with one end of the cable being inserted within the crimped wire insertion machine illustrated in FIG. 9.

FIG. 11 is a side perspective view of the crimped wire insertion machine of FIG. 9, including hardware for wire and contact insertion steps.

FIG. 12A is a side view of a part of the connector presenter slider and gripper and the side camera.

FIG. 12B is a camera view (from the perspective of the side camera illustrated in FIG. 12A) of the connector presenter slider and gripper.

FIG. 13A is a top view of the robot and wire gripper.

FIG. 13B is an expanded view of the top view illustrated in FIG. 13A.

FIG. 14 is a side view of the connector presenter slider and gripper.

FIGS. 15A-C are views of different parts of the connector presenter slider and gripper illustrated in

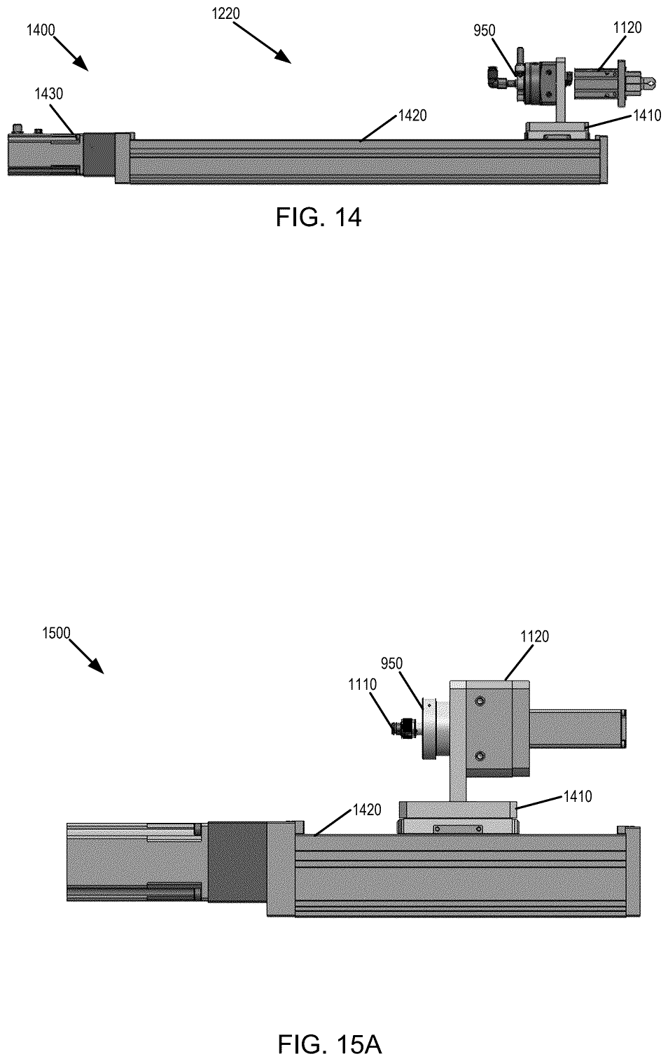

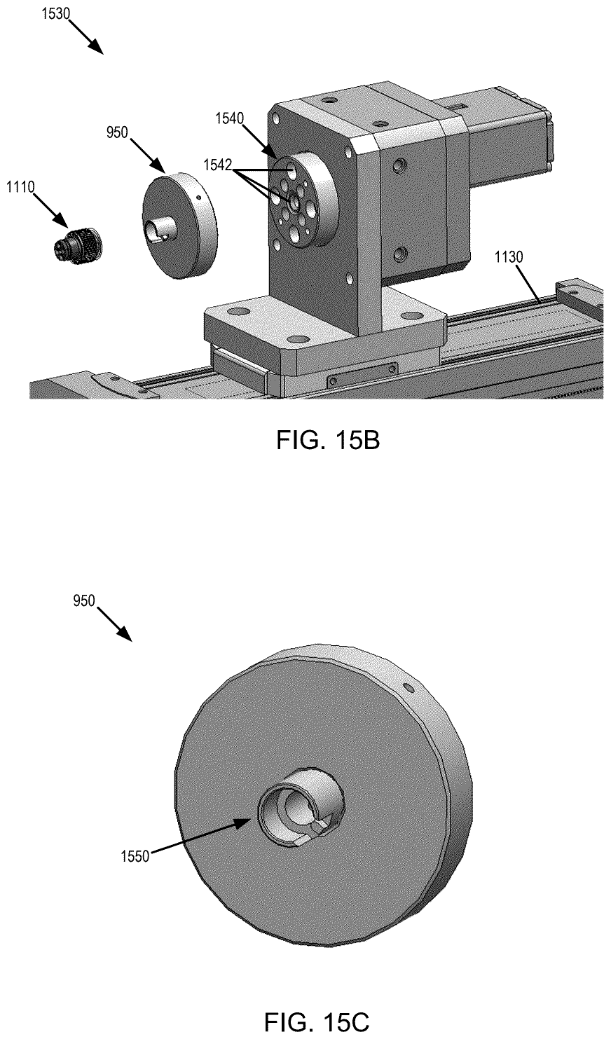

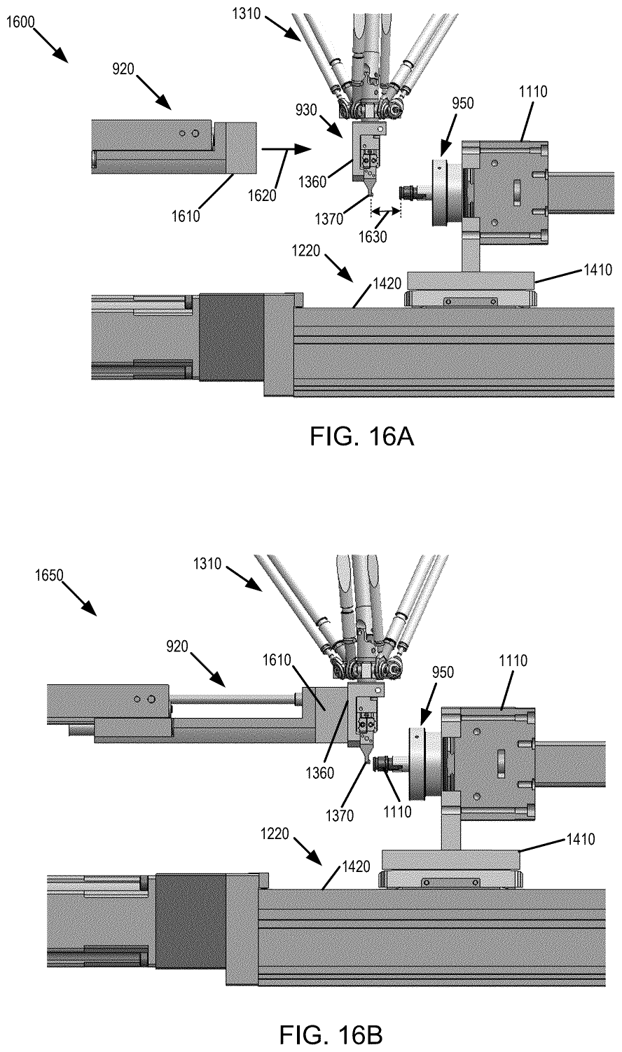

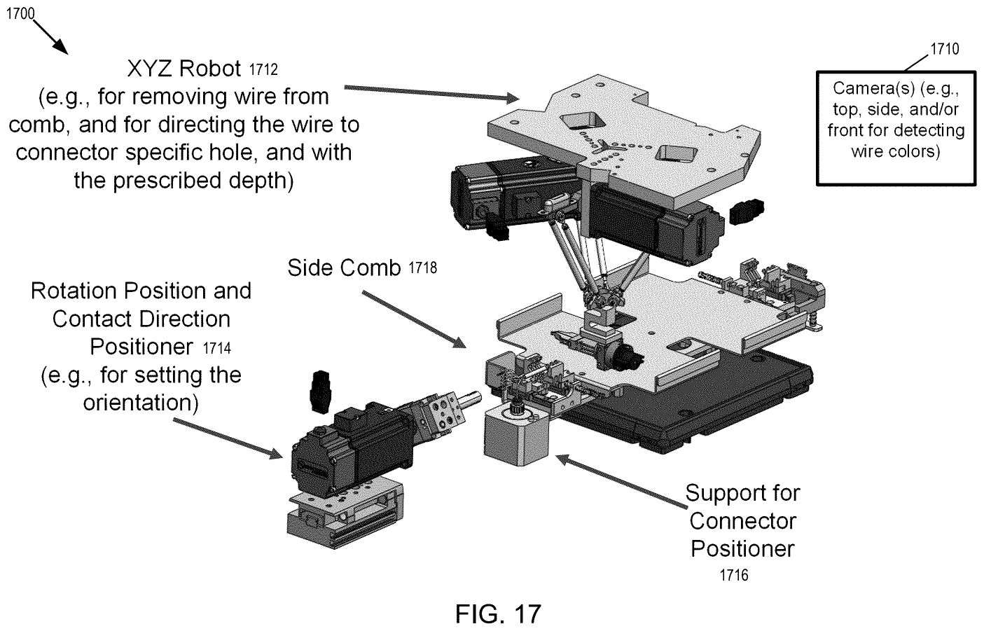

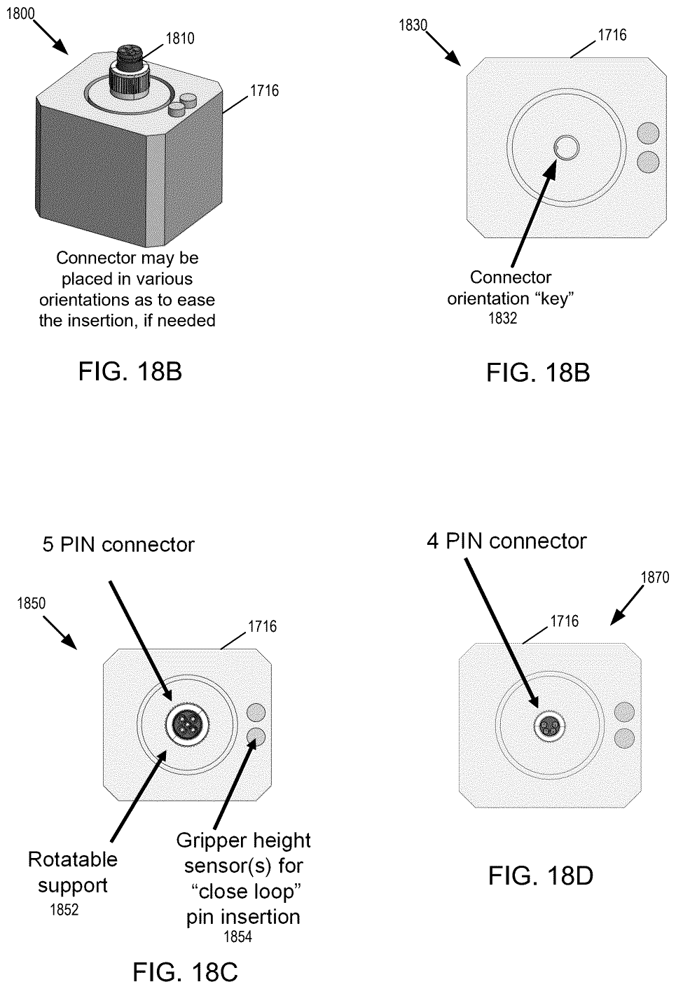

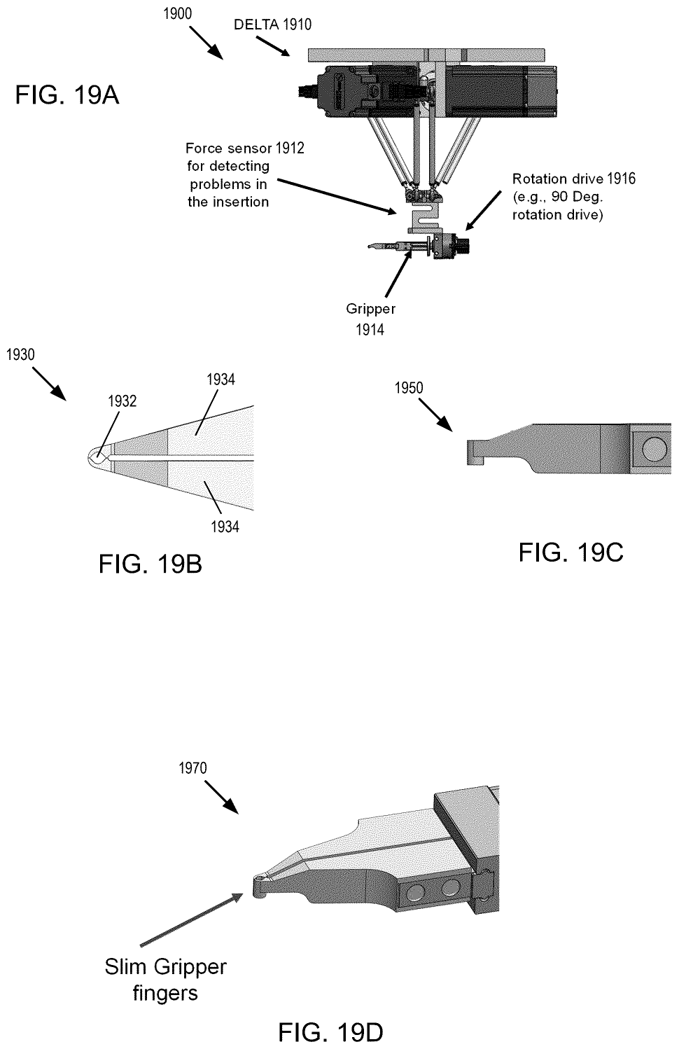

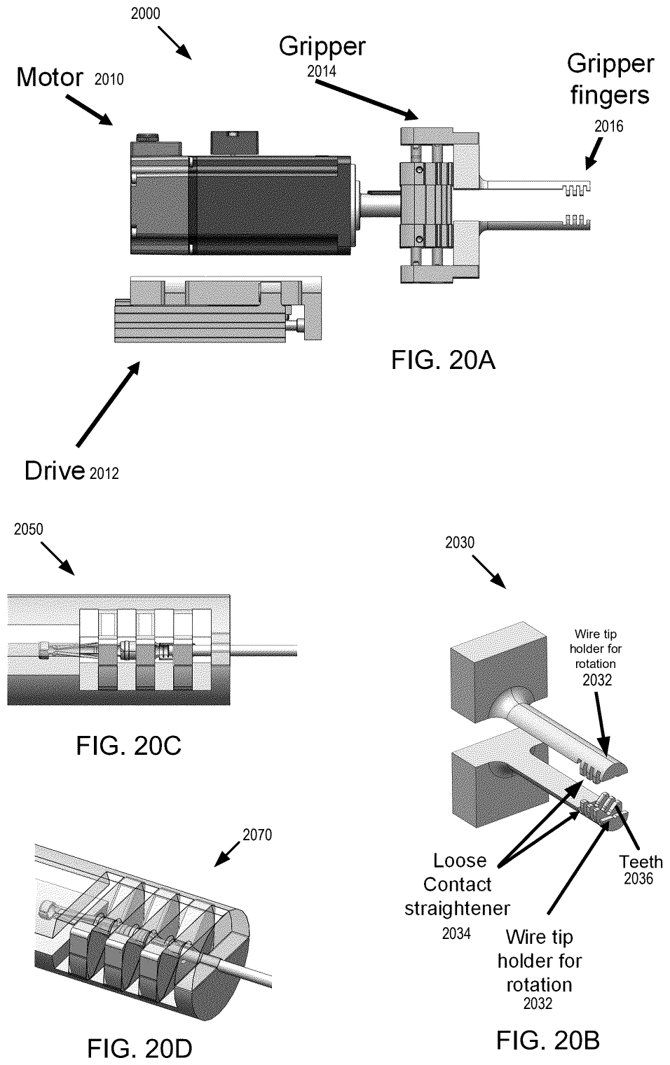

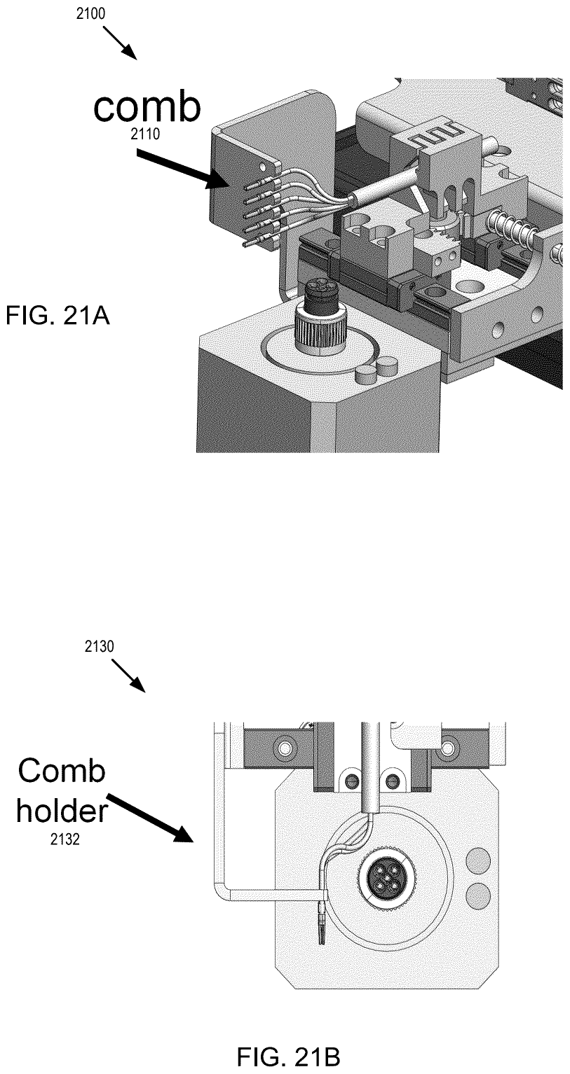

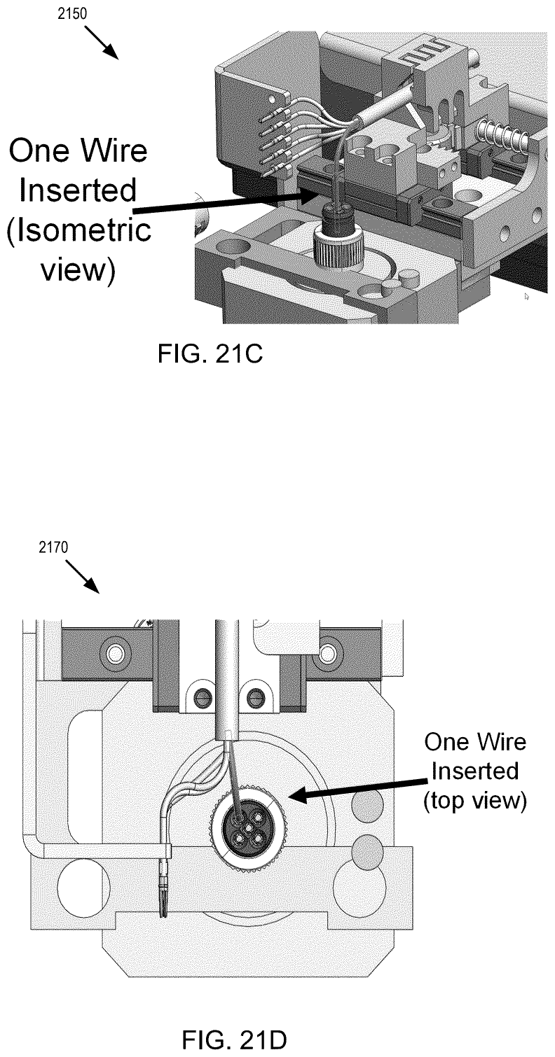

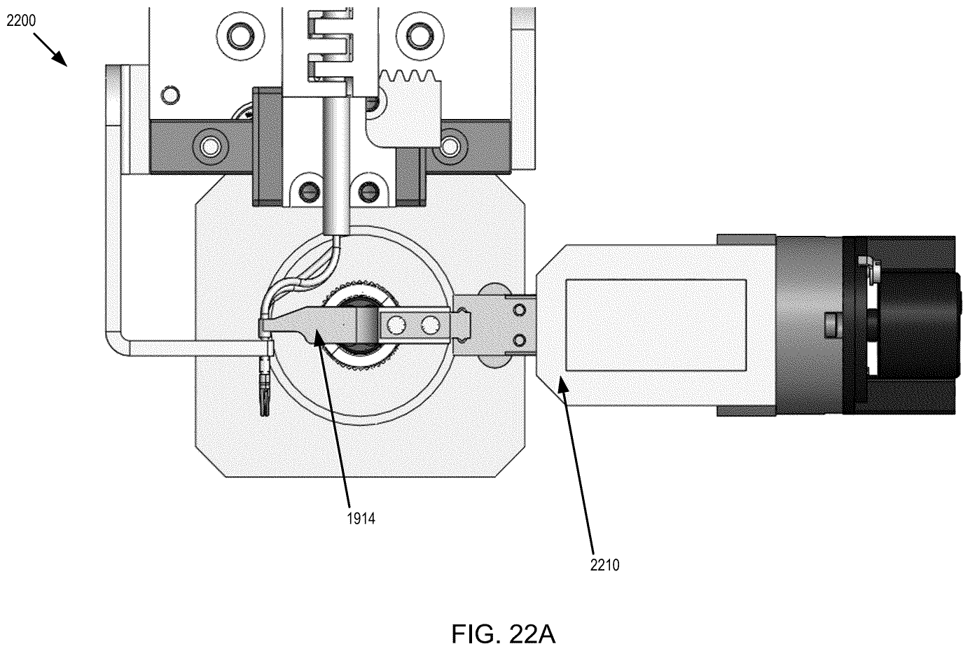

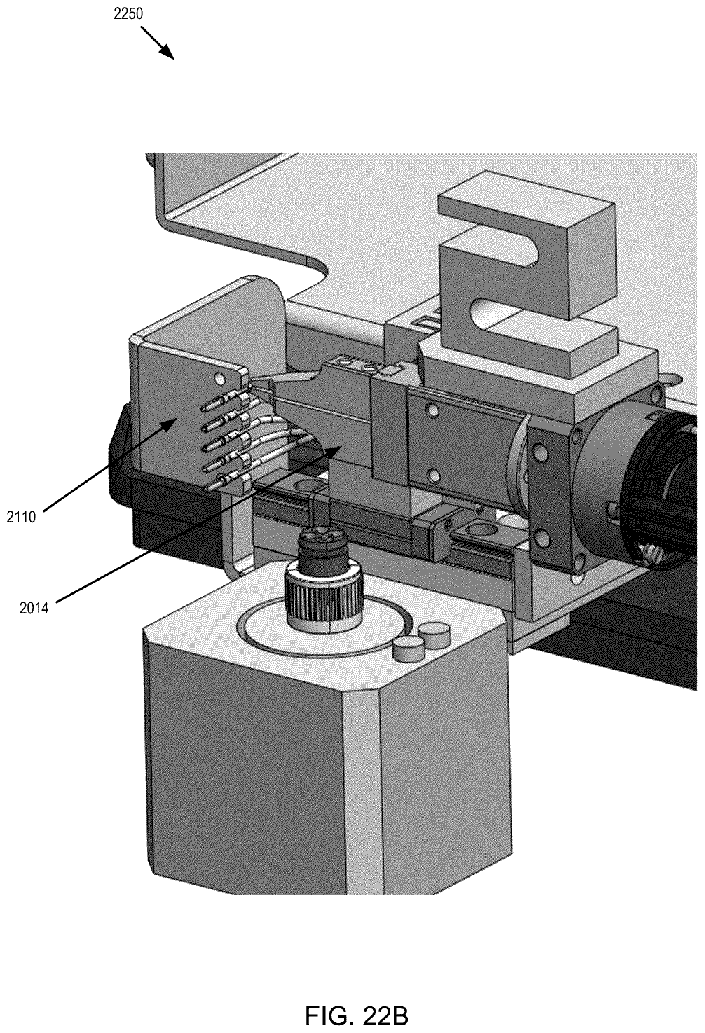

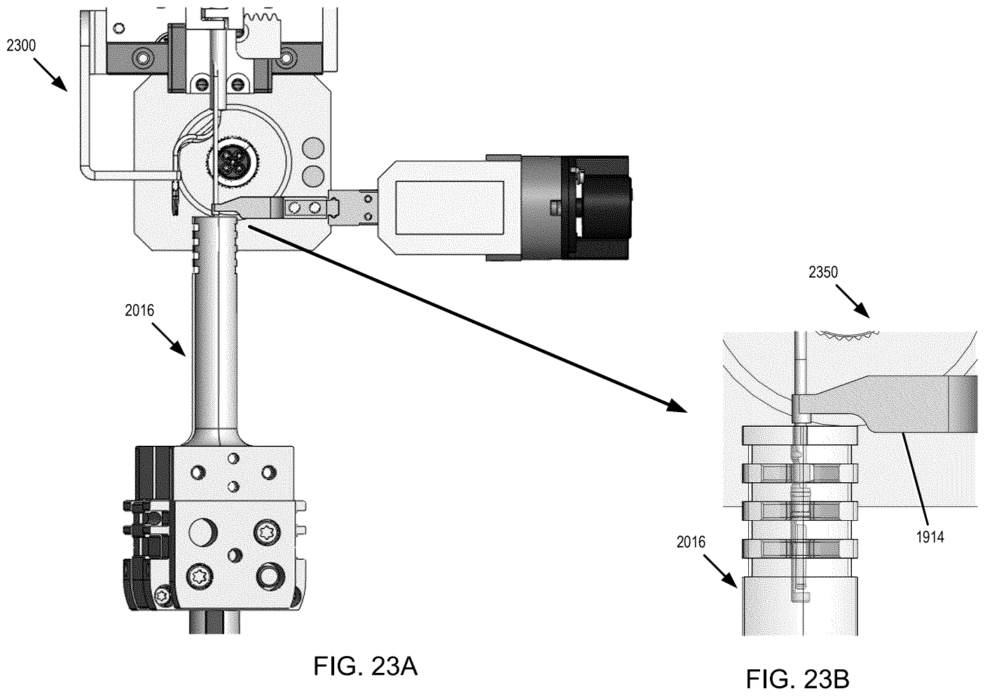

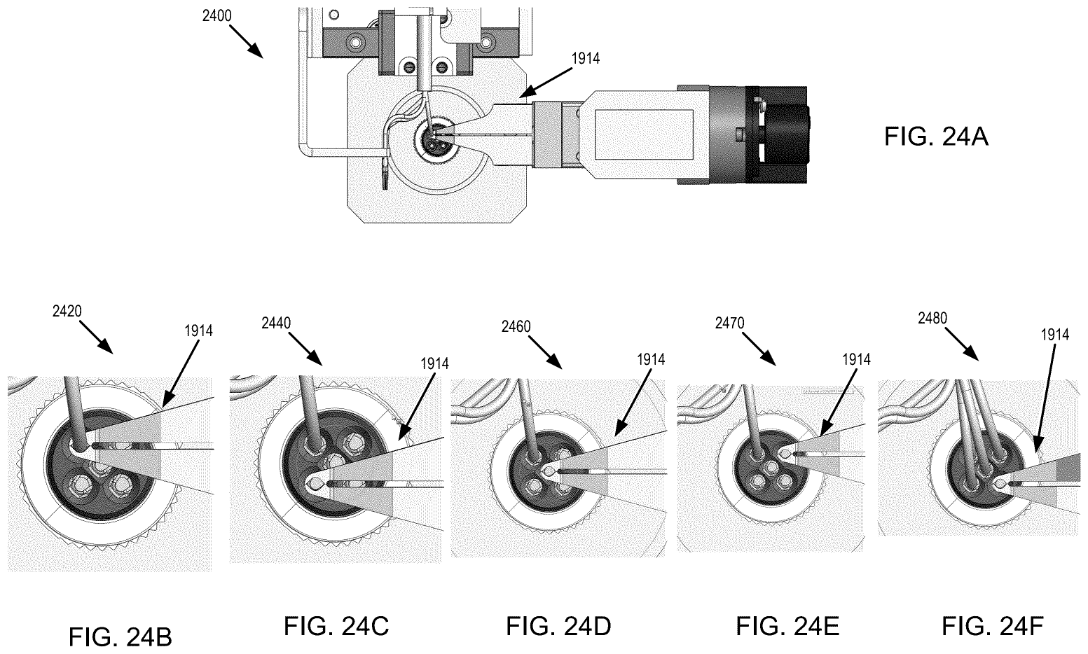

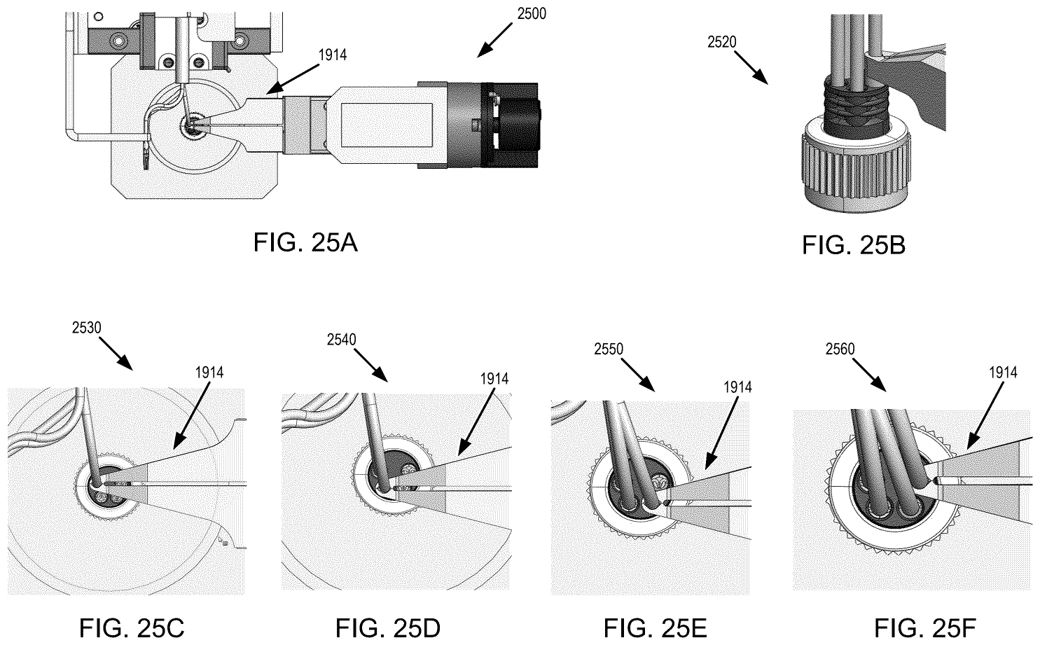

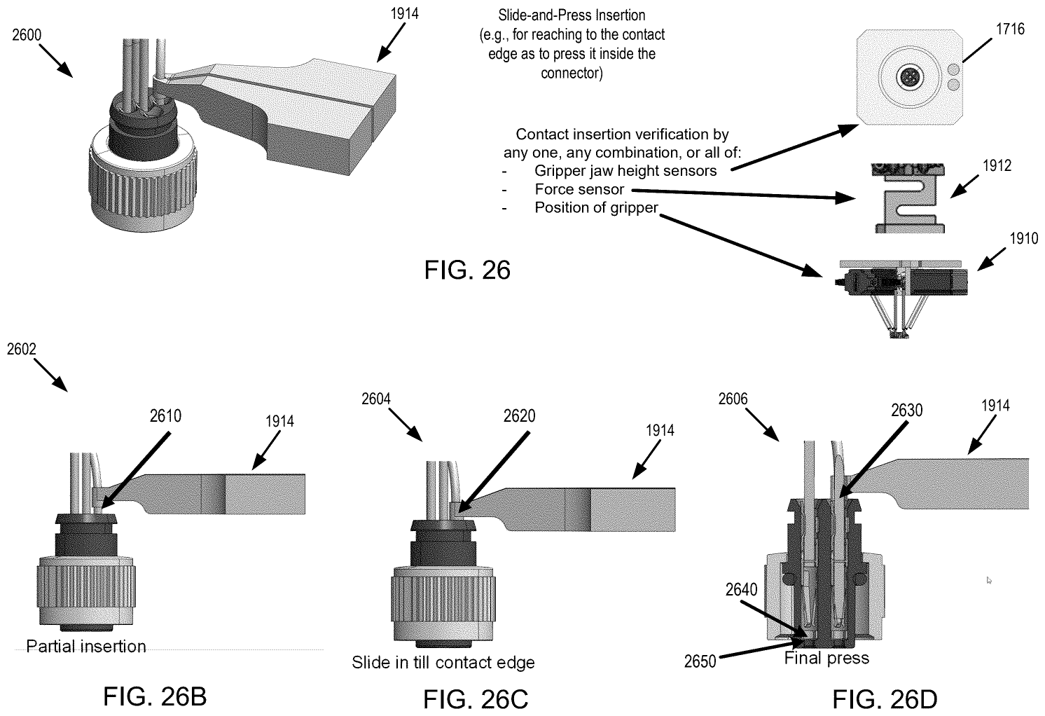

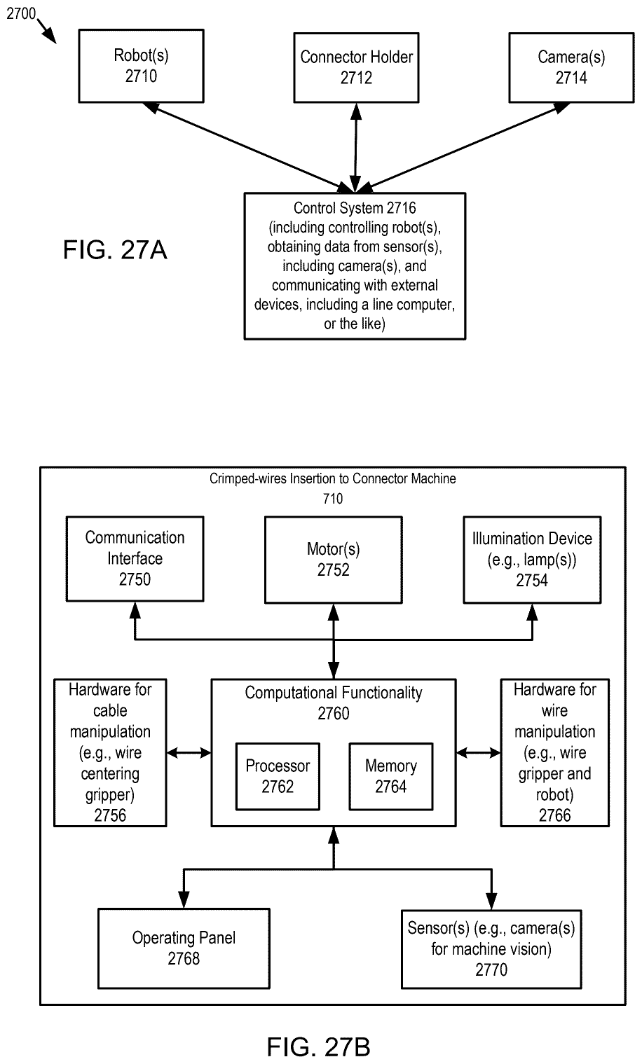

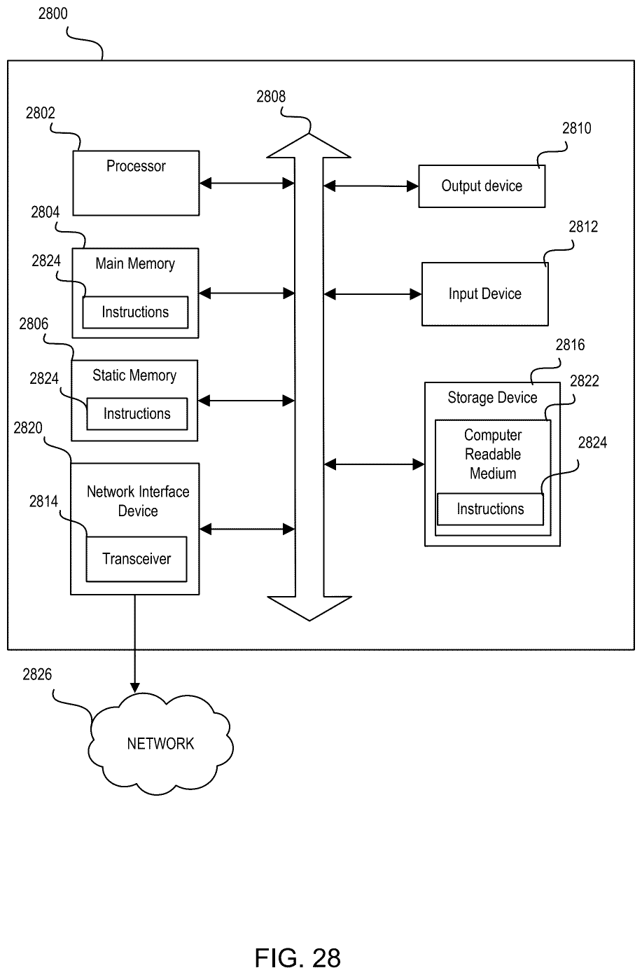

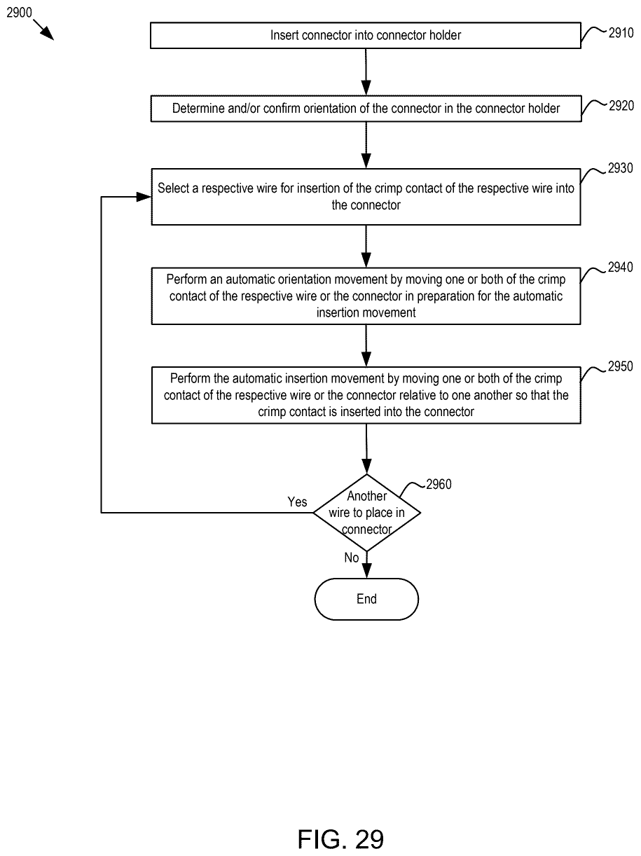

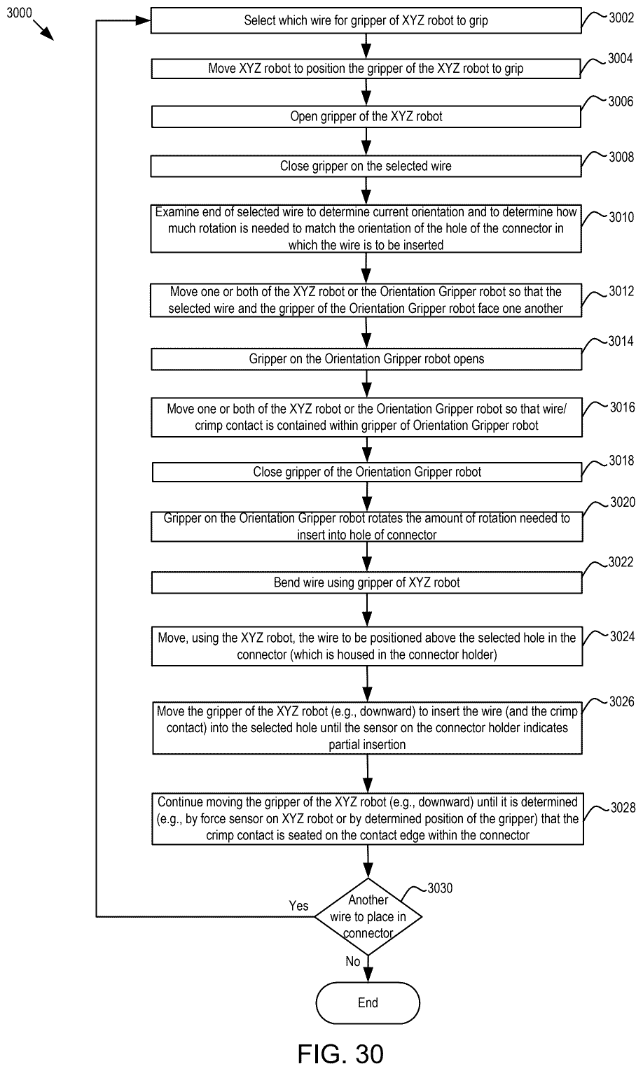

FIG. 14, including a partial side view in FIG. 15A, an exploded view in FIG. 15B, and the connector holder in FIG. 15C.

FIGS. 16A-B are views illustrating the force controlled insertion of the crimp contact into the connector housing.

FIG. 17 is an illustration showing different parts of the hardware which may be part of a crimped-wires insertion to connector machine.

FIG. 18A is an illustration of a connector holder that is configured to hold a connector.

FIG. 18B is top view of the connector holder illustrated in FIG. 19A with the connector orientation “key” illustrated.

FIG. 18C is a top view of the connector holder illustrated in FIG. 19A with a 5 pin connector inserted therein and illustrating a rotatable support and one or more gripper height sensors.

FIG. 18D is top view of the connector holder illustrated in FIG. 19A with a 4pin connector inserted therein and illustrating the rotatable support and one or more gripper height sensors.

FIG. 19A is an illustration of the wire move gripper device, with the delta (which may be an example of a robot or other motorized device configured to move the wire move gripper device), a sensor (which may comprise a force sensor configured to detect force during insertion of the wire/crimp contact into the connector in order to determine whether there are problems with insertion and/or to determine contact insertion verification (see FIG. 26C-D), and a gripper.

FIGS. 19B-D are top, side, and perspective views, respectively, of the gripper illustrated in FIG. 19A.

FIG. 20A is an illustration of the orientation gripper device.

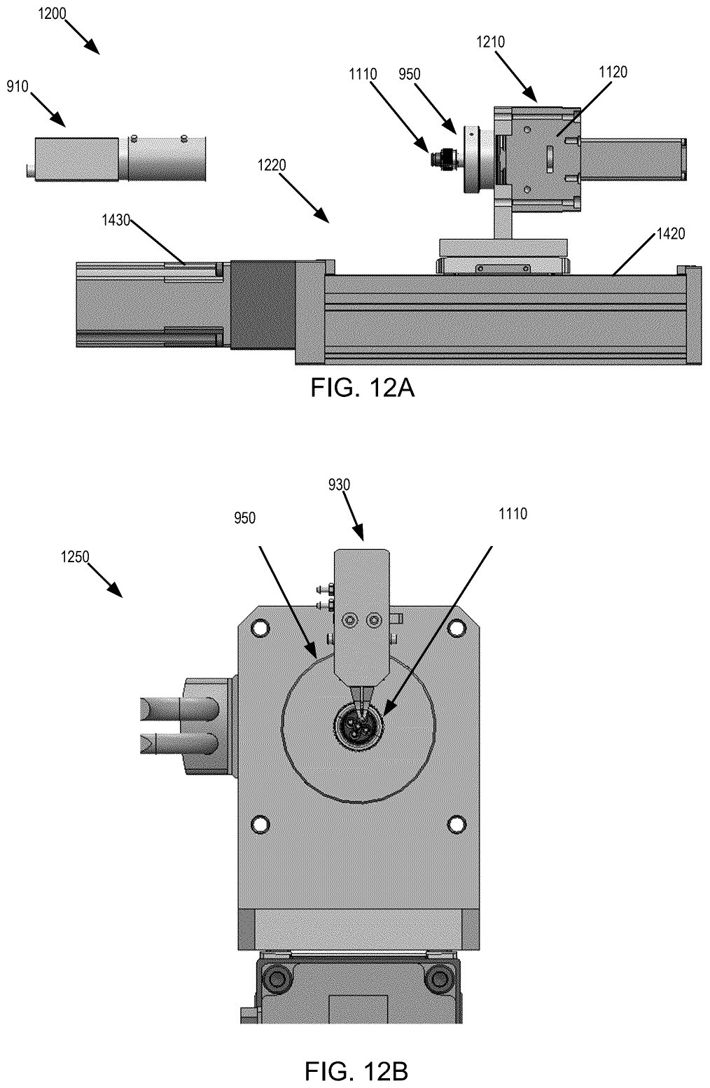

FIG. 20B is a perspective view of the gripper fingers illustrated in FIG. 12A.

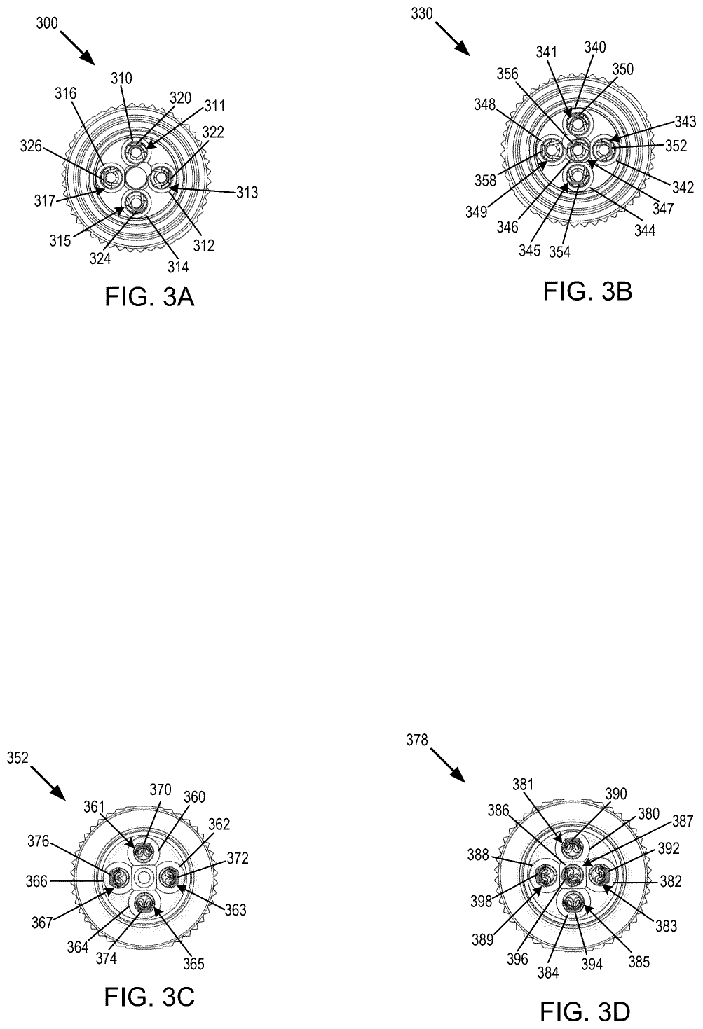

FIG. 20C is a side view of part of the gripper fingers gripping onto a wire and the crimp contact, illustrating that the gripper fingers may perform one or both of straightening a loose crimp contact or gripping onto the insulation layer of the wire in order to impart a force onto the wire/crimp contact to rotate the wire to the desired orientation for insertion (see FIGS. 3A-B and 4A-B).

FIG. 20D is a perspective view (with cutaway) illustrating the gripper fingers straightening the loose crimp contact and gripping onto the insulation layer of the wire in order to impart a force onto the wire/crimp contact to rotate the wire to the desired orientation for insertion (see FIGS. 3A-B and 4A-B).

FIGS. 21A-D illustrate an example sequence of wire insertion with FIG. 21A showing a perspective view of the wires connected to or attached to a comb, FIG. 21B showing a top view of FIG. 21A, FIG. 21C showing an isometric view of one wire/crimp contact having been inserted into a respective pin of the connector, and FIG. 21D showing a top view of FIG. 21C.

FIGS. 22A-B illustrate a top and a perspective view, respectively, of the wire move gripper device taking a wire/crimp contact from the comb.

FIG. 23A illustrates a top view of the system after the wire move gripper device has taken the wire/crimp contact from the comb but prior to the wire move gripper device inserting the wire/crimp contact into a respective pin of the connector, and illustrates the orientation gripper device interacting with the wire/crimp contact.

FIG. 23B illustrates an expanded view of FIG. 23A of the wire move gripper device and the orientation gripper device interacting with the wire/crimp contact.

FIG. 24A illustrates a top view of the wire move gripper device inserting a first wire/crimp contact into a respective pin of an M12 5-pin connector (held within the connector holder).

FIG. 24B illustrates a close up view of FIG. 24A of the gripper inserting the first wire/crimp contact into the respective pin of an M12 5-pin connector.

FIGS. 24C-F illustrate a close up view of the gripper inserting the second, third, fourth, and fifth wire/crimp contacts, respectively, into respective pins of an M12 5-pin connector.

FIG. 25A illustrates a top view of the wire move gripper device inserting a first wire/crimp contact into a respective pin of an M8 4-pin connector (held within the connector holder).

FIG. 25B illustrates a perspective view of the wire move gripper device inserting the fourth wire/crimp contact into a pin of an M8 4-pin connector (without illustrating the connector holder and after the first, second and third wires/crimp contacts have been inserted into their respective pins of the connector).

FIG. 25C illustrates a close up view of FIG. 25A of the gripper inserting the first wire/crimp contact into a pin of an M12 5-pin connector. FIGS. 25D-F illustrate a close up view of the gripper inserting the second, third, fourth, and fifth wire/crimp contacts, respectively, into respective pins of an M12 5-pin connector.

FIG. 26A illustrates a perspective view of the gripper inserting the wire/crimp contact into the connector and further illustrating the different devices, including sensor(s) on the connector holder, the force sensor on the wire move gripper device, and/or the position of the gripper (as determined by the wire move gripper device), that may be used for contact insertion verification.

FIG. 26B is a side view showing partial insertion (as shown by the gap) by the gripper of the wire/crimp contact into the connector.

FIG. 26C is a side view showing full insertion (as shown by no gap and where the gripper slides the wire/crimp contact until the crimp contact contacts the bottom edge of the connector).

FIG. 26D is a cutaway view of FIG. 26C showing full insertion in which the crimp contact is fully inserted, having contacted the bottom edge of the connector.

FIG. 27A is a block diagram of parts of the system.

FIG. 27B is a block diagram of the crimped-wires insertion to connector machine.

FIG. 28 is a block diagram of an exemplary computer system that may be utilized to implement the methods described herein, including implementing the control system illustrated in FIG. 27A and the computational functionality illustrated in FIG. 27B.

FIG. 29 is a first exemplary flow chart.

FIG. 30 is a second exemplary flow chart.

### DETAILED DESCRIPTION

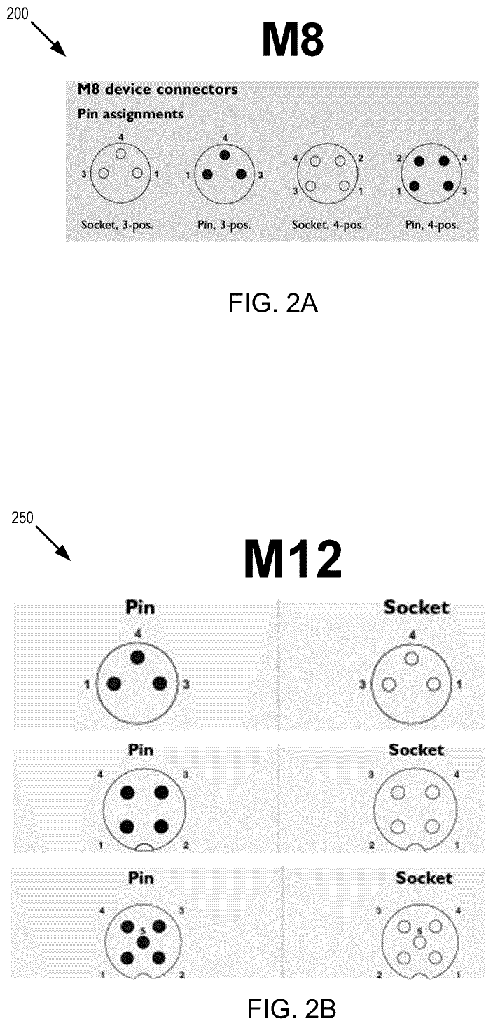

As discussed in the background, an end of a wire, having a crimp contact, may be inserted into a hole of a connector. However, this is typically a very labor-intensive process for several reasons. First, the area in which to work (e.g., inserting into a designated hole of the connector with the wire end/crimp contact) is very small and dense. This is especially true when the type of connector has a center wire (see M12 in FIG. 2B). Second, in certain instances, the wire end/crimp contact must be in a predetermined orientation to be inserted correctly into the respective hole of the connector. This is illustrated in FIGS. 3A-B and 4A-B. In particular, as discussed below, the respective hole of the connector may have a contact surface therein that is to physically and/or electrically contact a designated part of the crimp contact. In this regard, the crimp contact and the respective hole connector (when merging with each another by moving the crimp contact into the respective hole of the connector that is stationary, by moving the connector to the crimp contact that is stationary, or by moving both the crimp contact and the connector) need to proper orientation prior to insertion so that upon insertion, the contact surface of the respective hole contacts the designated part of the crimp contact. As discussed in more detail below, in preparation for the insertion, one or both of the orientation of a part of the wire (e.g., the crimp contact) or the connector may be modified or moved so that upon merging of the crimp contact with the hole (e.g., merging comprises moving one or both of the crimp contact or the connector), the contact surface of the respective hole contacts the designated part of the crimp contact. Third, certain types of connectors have different depths in which to insert the wire end/crimp contact. As one example, a first protocol may have different depth(s) of insertion than a second protocol. As another example. within a respective protocol, the different wires may have different depths of insertion. Merely by way of example, in a 5 pin layout in M12, the center pin may have a deeper depth in which to insert the respective wire end/crimp contact (e.g., 2 mm) than the depth of the surrounding pins (e.g., 1 mm). Any one, any combination, or all of these three issues make automation of inserting the wire end/crimp contact into the connector difficult.

Thus, in one or some embodiments, an automated method and an automated system are disclosed that are configured to address any one, any combination, or all of these three issues. As discussed in more detail below, one or both of an automatic orientation movement or an automatic insertion movement may be performed. In one or some embodiments, the automatic orientation movement may be performed prior to the automatic insertion movement in preparation to perform the automatic insertion movement. As discussed above, for proper electrical connection, after insertion of the crimp contact, the designated part of the crimp contact (e.g., that has an exposed wire) should physically contact the electrical contact surface of a respective hole in the connector. In this regard, the orientation of one or both of the crimp contact or the connector may be modified prior to the automatic insertion step (e.g., so that the orientation of the designated part of the crimp contact and the orientation of the electrical contact of the respective hole are the same). Thus, the automatic orientation movement may comprise changing the orientation of the crimp contact (e.g., rotating the crimp contact, such as moving in a radial direction, using a gripper holding the crimp contact or the wire); changing the orientation of the connector (e.g., the connector is held in a connector fixture; a motor is used to rotate the connector fixture in order to change the orientation of the connector); or changing the orientation of both the crimp contact and the connector. In this way, the automatic orientation movement may be performed in preparation the automatic insertion movement

In one or some embodiments, the automatic insertion movement comprises automatically performing: movement of the crimp contact into a respective hole of the connector (without the connector moving); movement of the connector without the crimp contact moving so that the crimp contact is inserted into the respective hole of the connector; or moving both the crimp contact and the connector so that the crimp contact is inserted into the respective hole of the connector. In one or some embodiments, because of the automatic orientation movement was previously performed (e.g., the orientation of the designated part of the crimp contact and the orientation of the electrical contact of a respective hole are the same), the automatic insertion movement consists of a lateral movement without any axial movement.

In one or some embodiments, prior to performing one or both of the automatic orientation movement or the automatic insertion movement, the wires may be spread out or moved apart. The wire may be spread apart in one or more ways. In one embodiment, the wires may be spread out on a comb. Alternatively, or in addition, the wires may be spread out on a surface (such as a flat surface).

Further, in one or some embodiments, when spreading out the wires, the crimp contacts for respective ends of the wires may be in a predetermined orientation (e.g., each crimp contact has its designated part (for contact with the electrical contact surface of the connector) facing upward). In particular, the wires may be spread as part of or resulting from the crimping process. As one example, the wires may be crimped so that after crimping, the crimp contact may be positioned on the wire in a predetermined manner or in a predetermined orientation (e.g., the crimp contact may be placed in a machine; an end of the wire thereafter inserted into the crimp contact; thereafter, the crimping process results in the crimp contact being crimped to the end of the wire in a predetermined manner; after which, the end of the wire, with the crimped contact crimped thereto, may be removed from the machine in a predetermined orientation (such as placed in a predetermined place on a comb or on a surface in the predetermined orientation).

Alternatively, the wires (and the respective crimp contacts) may be spread out (e.g., on the comb or on the surface) without the crimp contacts for respective ends of the wires being in the predetermined orientation. In such an instance, responsive to identification of the orientation of the crimp contact for a respective end (e.g., via analysis of an image generated by a camera to obtain the image of the crimp contact, such as when the crimp contact is held by the comb or on the surface), one or both of the crimp contact or the connector may be moved so that the crimp contact is in predetermined relation to a respective hole of the connector prior to merging of the crimp contact with the hole.

In one or some embodiments, after spreading of the plurality of wires, the wires may be selected, such as one-at-a-time, in order to sequentially perform for one, some or each of the plurality of wires the automatic orientation movement and the automatic insertion movement. In one or some embodiments, the sequence by which the wires are selected is based on one or more aspects of the wires, such as any one, any combination, or all of: a type of connector; a type of wire; a color of wire; or a position of wire (e.g., relative to the connector and/or relative to one or more other wires). In one or some embodiments, the type of connector may automatically dictate the sequence in which the wires are selected. By way of example, the type of connector may comprise an M8 connector (male or female) or an M12 connector (male or female). See FIGS. 3A-B and 4A-B. Given the type of connector (which may be automatically determined based on analysis of the connector itself (e.g., based on markings on the connector), based on pre-programming and/or based on operator input), the system may automatically determine a sequence of the wires to insert into the different holes of the connector so that there is less interference by wires already inserted for wires that still need to be inserted. In order to do this, for a respective type of connector, a sequence of filling of the holes may be predetermined. As one example, the holes may be filled in a clockwise manner (e.g., in the case of M12 male with four wires, the sequence may be as follows: the hole at 9:00; the hole at 12:00; the hole at 3:00; and finally the hole at 6:00). As another example, the holes may be filled in a counter-clockwise manner. As still another example, the holes may be filled left-to-right or right-to-left. As yet another example, the holes may be filled top-to-bottom or bottom-to-top (e.g., for top to bottom in the case of a M12 male with five wires (see FIG. 3A), the sequence may be as follows: the hole at the top (as shown in FIG. 3A for the white wire); the hole at the left (for the brown wire); the hole in the center (for the green-yellow wire); the hole at the right (for the blue wire); and finally the hole at the bottom (for the black wire)). Regardless.

Thus, in one or some embodiments, the one or more aspects of the wire may be determined by automatic analysis, such as automatic image analysis. As one example, after spreading of the plurality of wires, one or more images may be automatically obtained by a camera that is positioned proximate to the plurality of wires (e.g., positioned in fixed relation to the surface or the comb that holds the wires). The one or more images may be automatically analyzed to determine the one or more aspects of the wires, such as to automatically determine the colors of the respective wires. In turn, the wires may be selected based on the identified color for insertion into the respective hole designated for the wire. Merely by way of example, for top to bottom sequence in the case of a M12 male connector with five wires, the first wire selected is the white wire for insertion of the crimp contact into the top hole of the connector (as shown in FIG. 3A). After which, the brown wire is selected for insertion of the crimp contact into the left hole of the connector (as shown in FIG. 3A), and so on.

Thus, in one particular example, the colors of the wires may be white, blue, green, black, and brown. As discussed in more detail below, the M12 male connector (see FIG. 3A), which receives crimp contacts for wires that are white, blue, green, black, and brown, have a particular layout, as shown in FIG. 3A. In one or some embodiments, in order to reduce the possibility that the wires may block or make insertion more difficult, the sequence of wires (in this instance white, blue, green, black, and brown, though other sequences are contemplated, such as discussed above) are predetermined. Thus, in the particular example, the wires may be selected in that sequence (e.g., the wire identified as having a white insulated portion is selected first for insertion into the connector; after which, the wire identified as having a blue insulated portion is selected next for insertion into the connector; after which, the wire identified as having a green-yellow insulated portion is selected next for insertion into the connector; after which, the wire identified as having a black insulated portion is selected next for insertion into the connector; and after which, the wire identified as having a brown insulated portion is finally selected for insertion into the connector. In one or some embodiments, the spreading of the wires may be in any sequence. So that, the selection of the wires is not dependent on the positioning of the wires as spread out, but based on some aspect of the wires themselves.

Alternatively, or in addition, the one or more images may be automatically analyzed to determine positioning of the plurality of wires. As one example, the position may determine a spread of the wires on a surface to automatically determine the colors of the respective wires in the spread (e.g., from right to left, the wires are identified as green, blue, black, white, and brown). Based on the sequence, the wires may be selected based on the detected spread (in the given example, the green wire on the far right, followed by the blue wire, thereafter black, white and then brown).

Still alternatively, the wires may be organized on a surface or a comb based on a predetermined sequence. For example, in a desired sequence of inserting wires according to white, blue, green, black, and brown, the white wire may be positioned on the comb at the far right, followed by the blue wire second from the right, followed by the green wire in the middle, then followed by the black wire second from the left, and finally by the brown wire on the far left.

In this regard, the controller may select respective wire(s) for its crimp contact to be inserted into the connector based on one or both of: (i) based on one aspect(s) of the respective wire(s) (e.g., the color of the respective wire); (ii) based on the spread of the respective wire(s) (e.g., placement from left to right); or (iii) based on both aspect(s) of the respective wire(s) and the spread of the respective wire(s) (e.g., a first respective wire may be selected first based on being placed closest to the connector; after which, all remaining wires may be selected based on color so that the respective wires will not disturb or block one another in the insertion process).

Further, below are solutions directed to M8 and M12 connectors. It is noted, however, that these solutions are merely examples. In this regard, the disclosed automated method and automated system are not limited to those types of connectors and may be used with other connectors, such as other crimp-contact based connectors including D-Type connectors, military connectors, etc.

As discussed below, a connector may be used. The connector may comprise a bare connector, which may have defined holes, openings, or the like to accept the inserted contacts (e.g., the end wire/crimp contact). Further, as discussed below, the wires may have already been stripped of the isolation layer and crimped (e.g., with crimp contacts) and arranged on combs. Alternatively, the wires may be arranged or spread out on a flat surface. The wires may have various dimensions, such as a wire tip length of 17 mm to 50 mm and/or wire outer dimensions of 0.6 mm to 2 mm. Though, such dimensions are to be interpreted as non-limiting.

Various types of ways are contemplated in which a wire may be crimped with a crimp contact. One example way of crimping a wire with a crimp contact is disclosed in U.S. patent application Ser. No. 18/207,430, which is incorporated by reference herein in its entirety. Other ways are contemplated to crimp a wire with a crimp contact.

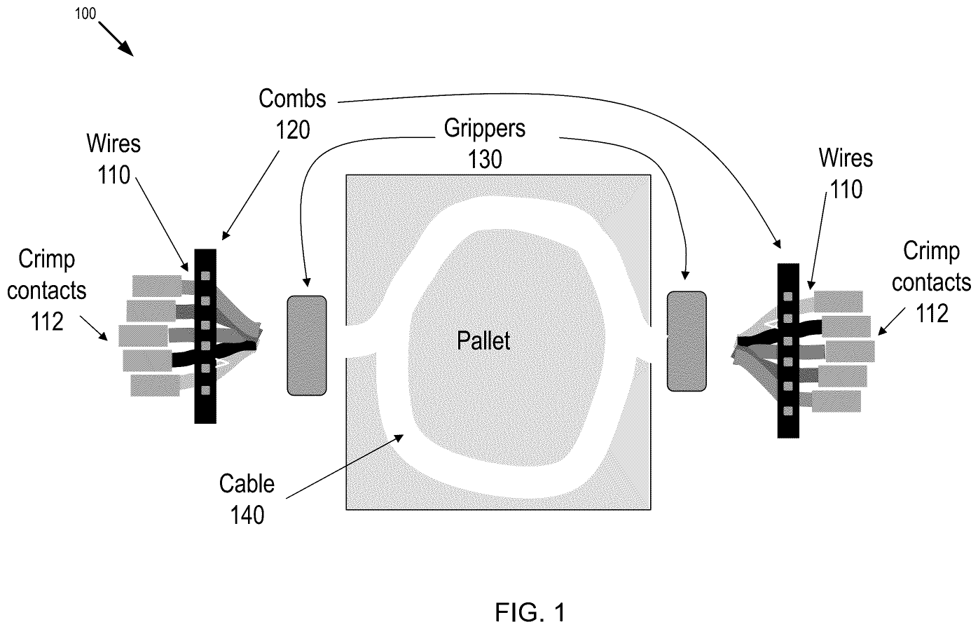

In addition, the cable may be held on a pallet. See FIG. 1. An example pallet is disclosed in U.S. Pat. No. 10,404,028, incorporated by reference herein in its entirety. Various numbers of wires in the cable are contemplated. Merely by way of example and not for limitation. 1-20 wires in cable may be used. It is noted, however, that the number of wires may depend on wire dimensions. Further, as discussed below, a color scheme may be provided so the software may automatically distinguish (based on image analysis) between the different wires. In a specific embodiment, the color scheme may be applied to the wires and/or to connector hole. In this way, the software may direct the specific wire to the specific hole in the bare connector. By way of example and not limitation, typical wire tip length are 17 to 50 mm and typical wire outer diameters from 0.6 to 2 mm. However, it is noted that the limitations depend on connector and crimp contact dimensions.

Thus, in one or some embodiments, an automatic orientation movement device and an automatic insertion movement device may both be in communication with a controller in order to perform, respectively, the automatic orientation movement by moving one or both of the crimp contact of the respective wire or the connector in preparation for an automatic insertion movement, and the automatic insertion movement of one or both the crimp contact of the respective wire or the connector by moving one or both of the crimp contact of the respective wire or the connector so that a designated part of the crimp contact physically contacts the electrical contact surface of respective hole of the connector. Various different types of automatic orientation movement devices and automatic insertion movement devices are contemplated. In one embodiment, the automatic orientation movement device comprises a gripper (which may include gripper fingers that include a contact straightener that has a plurality of teeth in order to guide the crimp contact to the modified orientation) and at least one motor, with the gripper configured to grip part or all of the crimp contact and the at least one motor is configured to rotate the gripper in order to modify orientation of the crimp contact. Alternatively, the automatic orientation movement device comprises a connector holder and at least one motor, where the connector holder is configured to hold the connector and the at least one motor is configured to rotate the connector holder, while the connector holder is holding the connector, in order to modify orientation of the connector. Moreover, in one embodiment, the automatic insertion movement device is configured to move the connector as the crimp contact is stationary. For example, the automatic insertion movement device may include at least one motor and a track device configured to move a support structure laterally via a track using the at least one motor, with the support structure connected to a connector holder, and with the connector holder configured to hold the connector. In this way, the automatic insertion movement device may move the support structure laterally via the track so that the connector, held in the connector holder is moved to the crimp contact. The automatic insertion movement device may further include one or both of: a gripper configured to grip the respective wire and hold the wire stationary as the connector holder moves laterally so that the connector contacts the crimp contact; or a side support device configured to move a side support into contact with the gripper so that the side support is configured to apply a force to at least a part of the gripper as the connector holder is moved so that the connector contacts the crimp contact.

In one or some embodiments, the automatic orientation movement device and the automatic insertion movement device include one or more common parts (that serve dual purposes of orientation and insertion). As one example, both the automatic orientation movement device and the automatic insertion movement device include a single connector holder that holds the connector, and that moves radially to perform the automatic orientation movement and moves laterally (e.g., along a track) to perform the automatic insertion movement (the same or different motors may be used to move radially and laterally). As another example, both the automatic orientation movement device and the automatic insertion movement device may include at least one gripper that is configured to hold the respective wire, wherein. while the at least one gripper is configured to hold the respective wire, an orientation gripper device is configured to rotate an end of the crimp contact, and wherein the at least one gripper is configured to move the crimp contact in order to perform the automatic insertion movement.

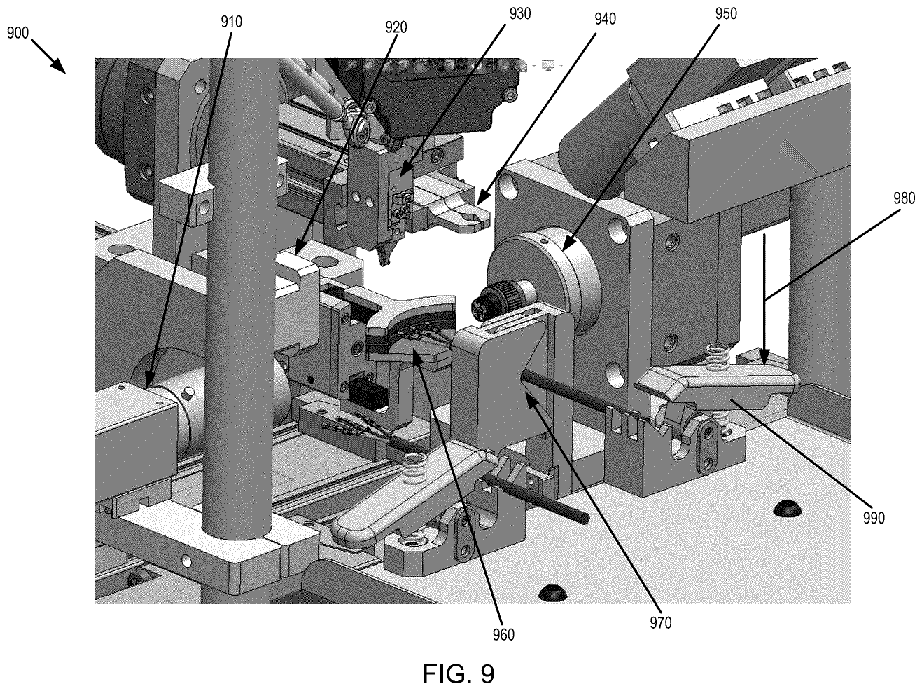

Referring to the figures, FIG. 1 is an illustration 100 of cables 140 and wires 110 on a pallet. As shown, the pallet may include two grippers 130/two combs 120 to hold both ends of the cable 140. As shown in FIG. 1, each end of the cable 140 has had the wires 110 stripped and crimp contacts 112 already crimped to the ends prior to insertion into the respective comb 120. Further, as shown in FIG. 1, the cable 140 includes 5 wires; however, fewer or greater numbers of wires are contemplated. Moreover, the pallet shows that the two ends of the cable 140 may be held by the two grippers 130/two combs 120 on opposite sides of the pallet. Alternatively, the two ends of the cable 140 may be held by grippers on a same side of the pallet, such as illustrated in FIG. 9, discussed further below.

FIGS. 2A-B are illustrations 200, 250 connectors including an M8 connector and M12 connector, respectively. Thus, various layouts for the connectors are contemplated. FIGS. 3A-D show illustrations 300, 330, 352, 378 of orientations of the M12 Male connector 4 poles (FIG. 3A), the M12 Male connector 5 poles (FIG. 3B). the M12 Female connector 4 poles (FIG. 3C), and the M12 Female connector 5 poles (FIG. 3D). In particular, FIG. 3A illustrates poles (or interchangeably holes) 310, 312, 314, 316 for white, blue, black and brown wires, respectively, corresponding electrical contact surfaces 320, 322, 324, 326 for the respective poles 310, 312, 314, 316, and crimp contacts 311, 313, 315, 317 oriented so that a predetermined part of the crimp contact abuts or is in physical contact with the electrical contact surfaces 320, 322, 324, 326. As shown, each of the electrical contact surfaces 320, 322, 324, 326 are on different portions of the respective pole 310, 312, 314, 316 (e.g., electrical contact surface 320 is on the top part of pole 310, electrical contact surface 322 is on the right side of pole 312, etc.), and where the orientation of the respective crimp contact 311, 313, 315, 317 may be different in order to contact the respective electrical contact surface 320, 322, 324, 326.

Similarly, FIG. 3B illustrates poles 340, 342, 344, 346, 348 for white, blue, black, green-yellow and brown wires, respectively, corresponding electrical contact surfaces 350, 352, 354, 356, 358 for the respective poles 340, 342, 344, 346, 348, and crimp contacts 341, 343, 345, 347, 349 oriented so that a predetermined part of the crimp contact abuts or is in physical contact with the electrical contact surfaces 350, 352, 354, 356, 358. Likewise, each of the electrical contact surfaces 350, 352, 354, 356, 358 are on different portions of the respective pole 340, 342, 344, 346, 348 (e.g., electrical contact surface 356 is at a 45° on the upper left of pole 346), and where the orientation of the respective crimp contact 341, 343, 345, 347, 349 may be different in order to contact the respective electrical contact surface 350, 352, 354, 356, 358. Thus, FIG. 3B illustrates various orientations, such as horizontal (see 350, 354), slanted up and to the right (see 356), and vertical (see 352, 358). These orientations are merely for purposes of example. In practice, the electrical contact portion of the respective crimp contact (such as the copper wiring exposed on the crimp contact) should be aligned with the respective orientation of the respective electrical contact surface. As discussed in more detail below, the system may rotate one or both of a respective wire end/crimp contact or the connector so that when inserted into the respective hole, the orientation matches with the inserted wire end/crimp contact for proper electrical contact.

FIG. 3C illustrates poles 360, 362, 364, 366 for white, brown, black, and blue wires, respectively. corresponding electrical contact surfaces 370, 372, 374, 376 for the respective poles 360, 362, 364, 366, and crimp contacts 361, 363, 365, 367 therein oriented so that a predetermined part of the crimp contact abuts or is in physical contact with the electrical contact surfaces 370, 372, 374, 376. As shown, each of the electrical contact surfaces 370, 372, 374, 376 are on different portions of the respective pole 360, 362, 364, 366 (e.g., electrical contact surface 370 is on the top part of pole 360, electrical contact surface 372 is on the right side of pole 362, etc.), and where the orientation of the respective crimp contact 361, 363, 365, 367 may be different in order to contact the respective electrical contact surface 370, 372, 374, 376.

Similarly, FIG. 3D illustrates poles 380, 382, 384, 386, 388 for white, brown, black, green-yellow, and blue wires, respectively, corresponding electrical contact surfaces 390, 392, 394, 396, 398 for the respective poles, and crimp contacts 381, 383, 385, 387, 389 therein oriented so that a predetermined part of the crimp contact abuts or is in physical contact with the electrical contact surfaces 390, 392, 394, 396, 398. Likewise, each of the electrical contact surfaces 390, 392, 394, 396, 398 are on different portions of the respective pole 380, 382, 384, 386, 388 (e.g., electrical contact surface 396 is at a 45° on the lower left of pole 386), and where the orientation of the respective crimp contact 381, 383, 385, 387, 389 may be different in order to contact the respective electrical contact surface 390, 392, 394, 396, 398.

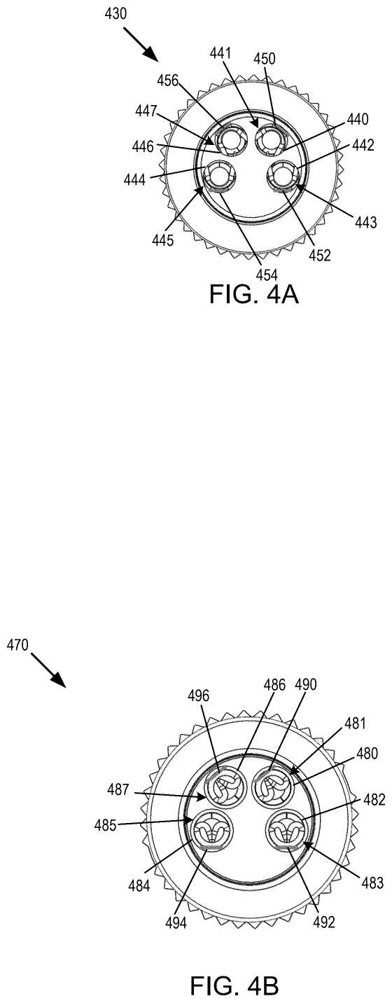

FIGS. 4A-B show illustrations 430, 470 of orientations of the M8 Male connector 4 poles (FIG. 4A) and the M8 Female connector +poles (FIG. 4B). In particular, FIG. 4A illustrates poles 440, 442, 444, 446 for white, brown, blue and black wires, respectively, corresponding electrical contact surfaces 450, 452, 454, 456 for the respective poles, and crimp contacts 341, 343, 345, 347 therein oriented so that a predetermined part of the crimp contact abuts or is in physical contact with the electrical contact surfaces 450, 452, 454, 456. Likewise, some of the electrical contact surfaces 450, 452, 454, 456 are on different portions of the respective pole 440, 442, 444, 446, and where the orientation of the respective crimp contact 341, 343, 345, 347 may be different in order to contact the respective electrical contact surface 450, 452, 454, 456.

FIG. 4B illustrates poles 480, 482, 484, 486 for black, blue, brown, and white wires, respectively. corresponding electrical contact surfaces 490, 492, 494, 496 for the respective poles, and crimp contacts 481, 483, 485, 487 therein oriented so that a predetermined part of the crimp contact abuts or is in physical contact with the electrical contact surfaces 490, 492, 494, 496.

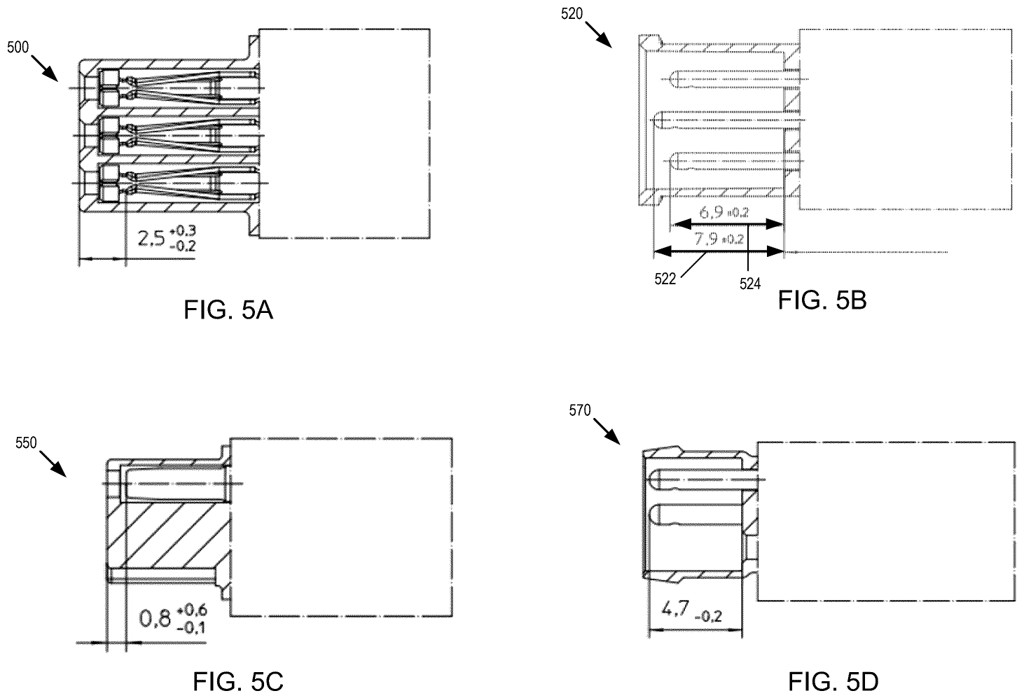

FIGS. 5A-D are illustrations 500, 520, 550, 570 showing the terminal depth for the connectors, which may vary based on which connector (e.g., M8 connector versus M12 connector) or which may vary based on the pin within the connector (e.g., middle pin of a 5 pin connector is at a different depth, such as at a deeper depth, than the outer pins of the 5 pin connector). In particular, FIG. 5A depicts an M12 female connector where the of the crimp contacts inserted therein is the same. In contrast, FIG. 5B depicts an M12 male connector in which the terminal depths are different, as shown by lengths 522, 524. FIG. 5C depicts an M8 female connector of different terminal depths as well. And, FIG. 5D depicts an M8 male connector with a same depth. In this regard, the disclosed automated system and automated method enables insertion the wire end/crimp contact to different depths, such as illustrated in FIGS. 5A-D (whether different depths for different types of connectors or different depths for different wires in the same connector). In particular. FIGS. 5A-D show different numbers (in cm) of depths. As such, the system may be configured to determine the type of connector, and insert crimp contacts at different depths dependent on which type of contact is being used. In one embodiment, the determination of the type of contact may be automatically determined, such as using a side camera, discussed in more detail below, or may be determined at least partly manually, such as via input by an operator. In either instance, the specifications of placement, depth, etc. for the respective connector may be automatically programmed into the crimped-wires insertion to connector machine (see 710 below) responsive to determining the type of connector.

Moreover, as discussed in more detail below, one or both of the wire gripper and robot 930 or the connector presenter slider and gripper 1220 may move so that the crimp contact is inserted into the connector. As one example, the wire gripper and robot 930 (which holds the wire) is stationary and the connector presenter slider and gripper 1220 (which holds the connector) moves so that the connector moves to the crimp contact for the crimp contact insertion. As another example, the wire gripper and robot 930 (which holds the wire) moves and the connector presenter slider and gripper 1220 (which holds the connector) is stationary so that the crimp contact moves to the connector for the crimp contact insertion. As yet another example, both the wire gripper and robot 930 (which holds the wire) and the connector presenter slider and gripper 1220 (which holds the connector) move so that the crimp contact is inserted into the connector. As discussed in more detail below, the amount of relative movement (such as movement of one or both of the wire gripper and robot 930 and the connector presenter slider and gripper 1220) is dependent on the depth in which the crimp contact is to be inserted within the connector (with the depth being stored in crimped-wires insertion to connector machine in order to perform the automatic insertion). Thus, separate from aligning the orientation (discussed above with regard to FIGS. 3A-D and 4A-D, and discussed further below), the system may automatically control movement of one or both of the crimp contact or the connector so that the insertion is at the prescribed depth.

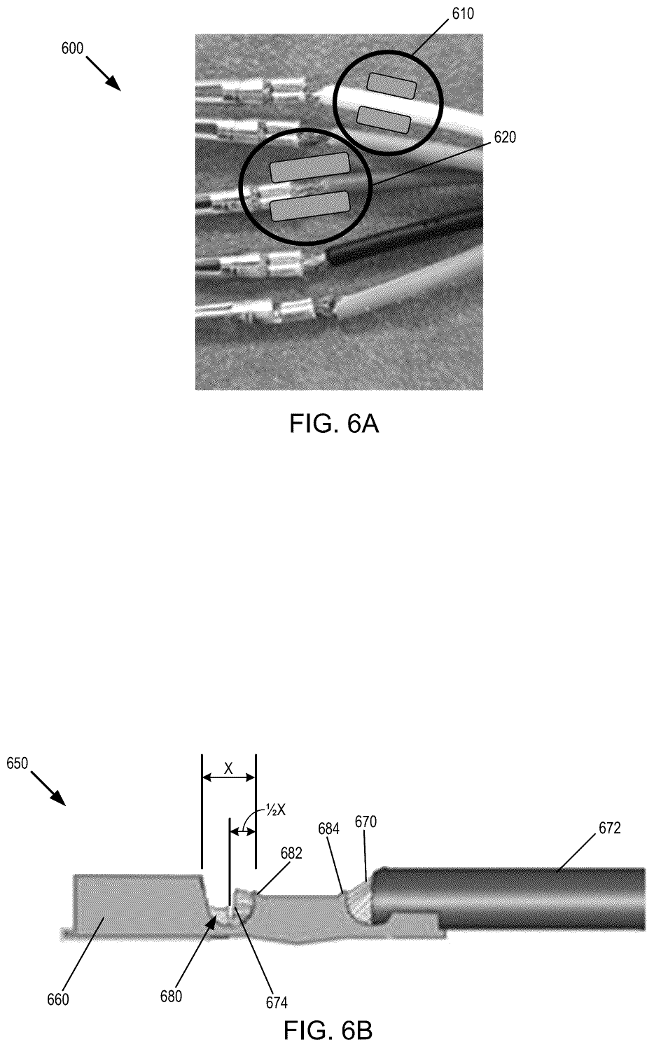

Generally speaking, the wire may be held in one of several places. Merely by way of example, FIG. 6A is an illustration 600 of where the gripper(s) may hold the wires, such as holding on the wires on the isolation layer (see 610) and/or on the area connecting the wires to the crimp contact (see 620).

FIG. 6B is a side view 650 of the wire of the cable after having been crimped with the crimp contact 660. The wire includes a conductive portion 670 and an insulated portion 672. Crimp contact includes a crevice 680 and edges 682, 684, with FIG. 6B illustrating a recommended positioning of the conductive portion 670 within crimp contact 660 after crimping. As one example, edge 674 of conductive portion 670 is positioned ½ in crevice. Further, conductive portion 670 touches both edges 682, 684. In this way, the conductive portion 670 within crevice 680, when positioned properly prior to insertion, may make contact with the respective electrical contact surface of the connector (such as illustrated in FIGS. 3A-D and 4A-D).

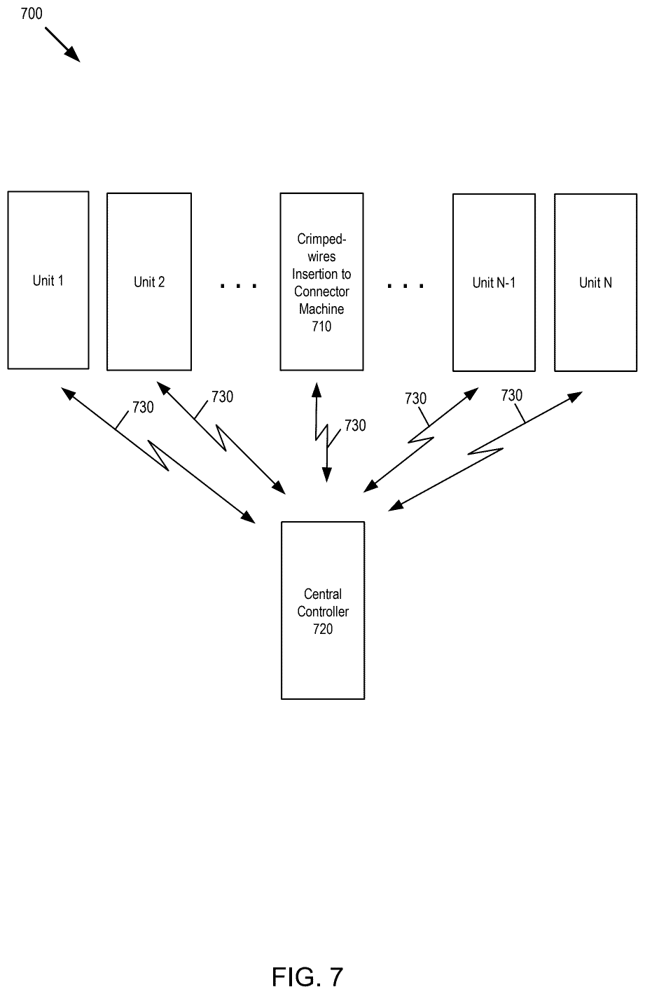

In one embodiment, the automated system and automated method may be part of a standalone solution. Alternatively, the automated system and automated method may be part of an automatic line, such as illustrated in FIG. 7, which is a block diagram 700 of one example layout in which a crimped-wires insertion to connector machine may be placed within a plurality of other machines as part of a production line. In particular, crimped-wires insertion to connector machine 710 may be part of a line, which may further include one or more other units, such as unit 1, unit 2, . . . unit N-1, unit N, and may be controlled by a central machine, such as central controller 720. Central controller 720 may communicate with the plurality of machines on the production line, such as crimped-wires insertion to connector machine 710, by wired and/or wireless communication, such as illustrated by 730.

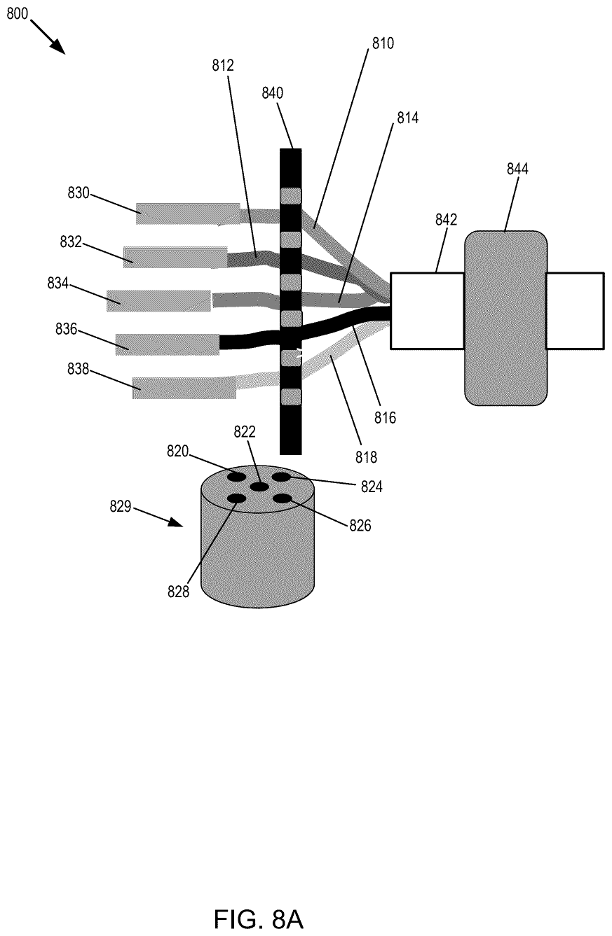

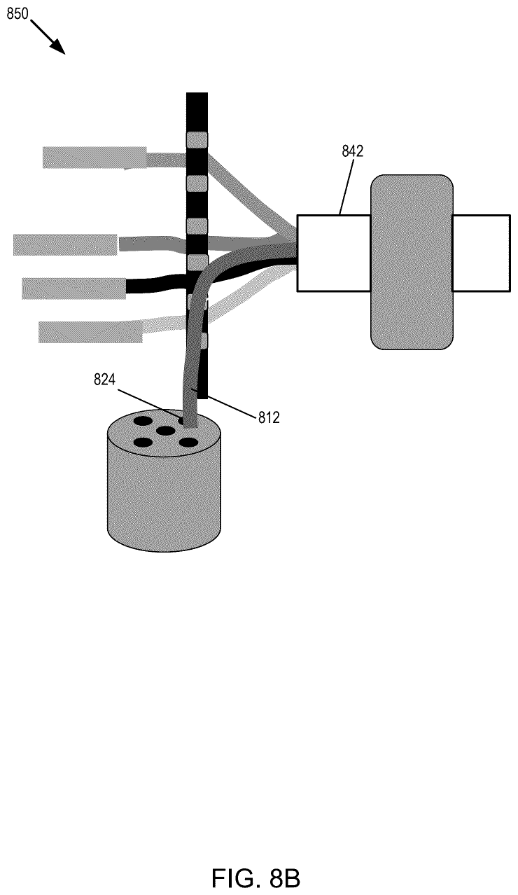

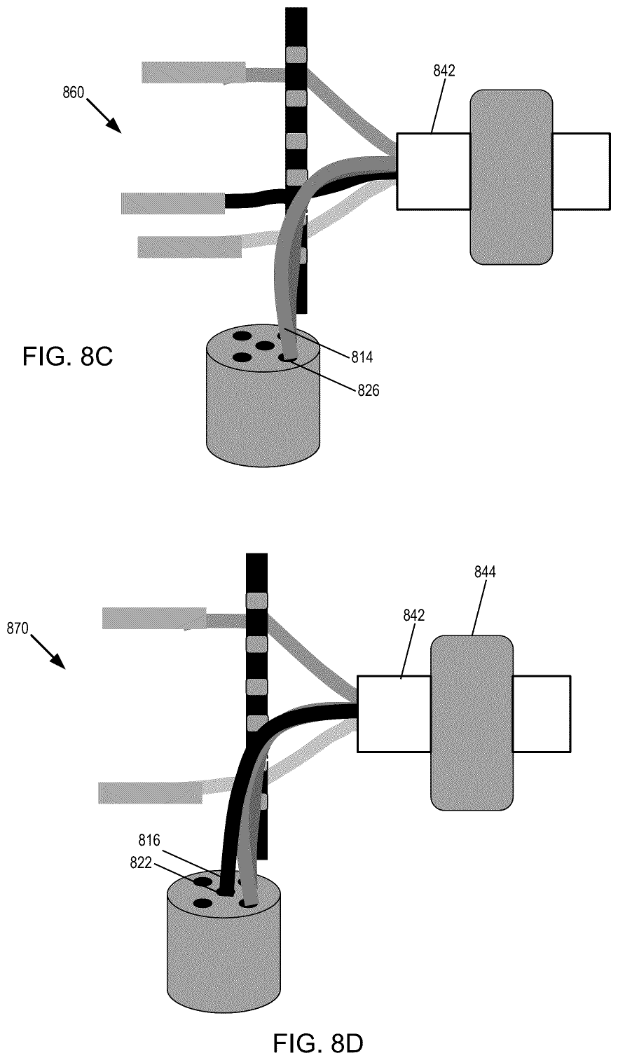

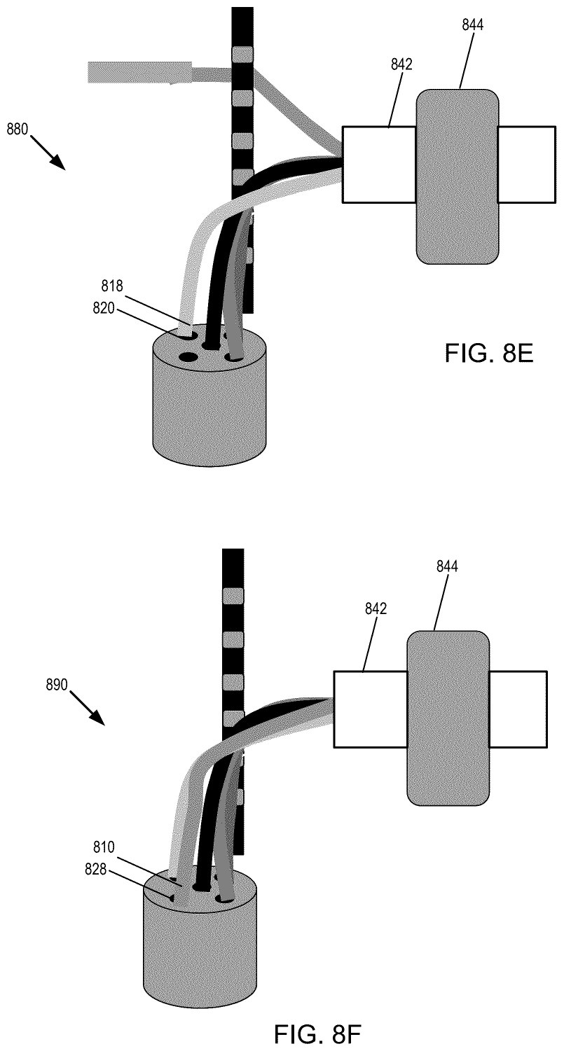

FIG. 8A is an illustration 800 of an example initial state of the wires 810, 812, 814, 186, 818, with crimp contacts 830, 832, 834, 836, 838, placed on a comb 840, with the wires 810, 812, 814, 186, 818 being part of cable 842 that is held by gripper 844. As shown, the ends of the wires 810, 812, 814, 186, 818 are already stripped, with crimp contacts 830, 832, 834, 836, 838 crimped or attached thereon, and placed on the comb 840. FIG. 8A further illustrates the bare connector 829, which does not have, as yet, any wire ends/crimp contacts inserted therein. FIGS. 8B-F are illustrations 850, 860, 870, 880, 890 of a sequence of inserting, wire-by-wire, the wires (with crimp contacts) into the connector.

In one embodiment, the software may identify the wires based on dynamic analysis, such as by using one or more cameras to determine the color of a respective wire, and based on the determined color, determine in which order and in which respective hole in the connector to insert the respective wire. In particular, the software may read the wire colors once, then may direct the wires to the defined holes in the bare connector until completion. See FIGS. 8B-F. For example, wires 810, 812, 814, 816, 818 may be identified by color. After which, the software may identify the proper sequence of selecting the wires and in which of the holes 820, 822, 824, 826, 828 of the bare connector to insert the respective wires therein. As shown, FIG. 8B illustrates wire 812 inserted into hole 824, FIG. 8C illustrates wire 814 inserted into hole 826, FIG. 8D illustrates wire 816 inserted into hole 822, FIG. 8E illustrates wire 818 inserted into hole 820, and FIG. 8F illustrates wire 810 inserted into hole 828.

In one embodiment, the wires may be placed randomly onto the comb, with the system identifying, by color, the respective wire, as discussed above. For example, this is illustrated in FIGS. 8A-E, in which the wires may first be identified by color, and then moved to the correct hole. Alternatively, the system may place the wires on the comb (or other type of holder) or place the wires on a surface in a predetermined arrangement. In this way, the position of the wire within the comb may identify the respective wire, thereby not requiring optical analysis. Alternatively, or in addition, the holes on the connector may be identified in various ways. In one embodiment, the holes of the connector may likewise be color coded. In another embodiment, the top face of the connector may have an icon or the like to identify the orientation. In still another embodiment, a connector holder may have an adapter, which may comprise a connector orientation key, in order to properly orient the connector in a predetermined manner (as discussed further below with regard to FIGS. 15B-C. See also FIG. 19B. Alternatively, or in addition, after identifying the connector, the connector may be moved or rotated to a predetermined orientation. This is illustrated by rotatable support of connector holder in FIG. 19C.

FIG. 9 is a perspective view 900 of a first example of the crimped wire insertion machine. As shown, the crimped wire insertion machine may include a side inspection camera 910, wire gripper and robot 930, side robot support 920, connector presenter 940, connector holder 950, cable centering gripper 970, and crimp contacts position gripper 960 (alternatively termed crimp contacts holder). Side inspection camera 910 is configured to generate images of one or more aspects of one or both of the cable or the connector. As one example, the side inspection camera 910 may obtain images of the wire(s) in the cable in order to verify or identify the color and/or position of a respective wire.

As discussed above, the wires may already have crimped thereon crimp contacts, such as disclosed in U.S. patent application Ser. No. 18/207,430, which is incorporated by reference herein in its entirety, which may, in one embodiment, be performed by a separate predecessor machine on the line, such as illustrated in FIG. 7. Other ways are contemplated to crimp a wire with a crimp contact. In one or some embodiments, this separate predecessor machine tasked with performing the crimping may place each of the crimp contacts of the wires for a respective end of the cable in a predetermined orientation (e.g., the “B shape” of the crimp for each crimp contact facing downward).

As discussed below in FIGS. 16A-B, the wire gripper and robot 930 and the side robot support 920 may work in combination with the connector presenter slider and gripper 1220 in order to insert a respective crimp contact into a hole of the connector, as discussed further below.

Further, in one or some embodiments, the connector presenter 940 may be configured to grip or move a connector and insert the connector into the connector holder 950. As discussed in more detail below with regard to FIGS. 15C and 30, the connector may be inserted into the connector holder 950 in one of a predetermined orientation (e.g., by being guided into a predetermined orientation via an adapter 1550 or the like, as discussed in FIG. 15C) or a random orientation (after which, the actual orientation of the connector after having been placed in the connector holder 950 may be determined by camera 910). Thus, in one or some embodiments, the connector may be placed within the connector holder 950 and/or the orientation of the connector in the connector holder 950 may be determined (e.g., after placing the connector in the predetermined orientation in the connector holder 950, the camera 910 may confirm that the connector is in the predetermined orientation in the connector holder 950).

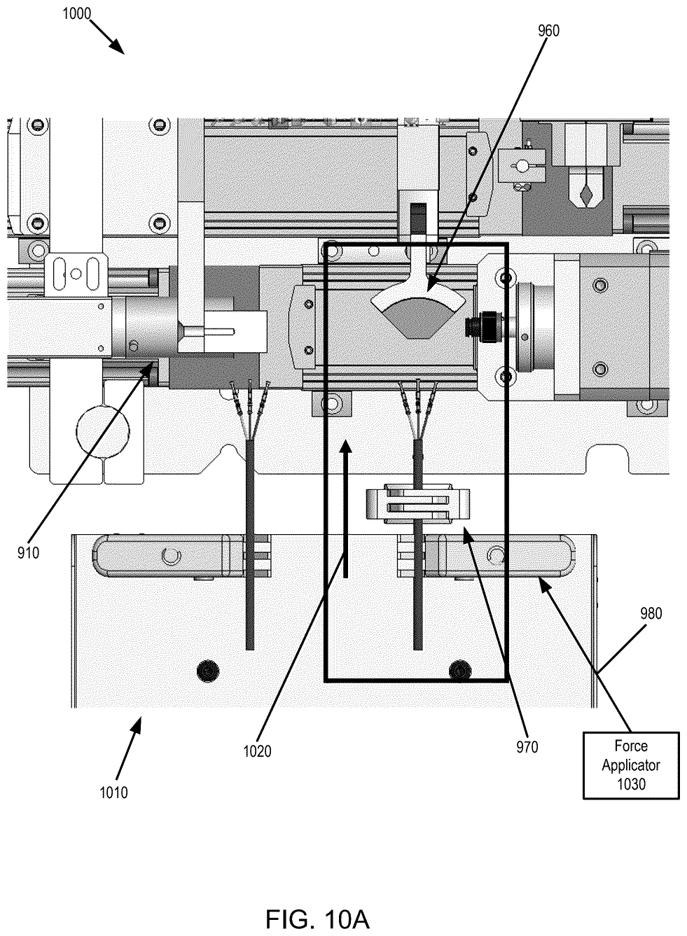

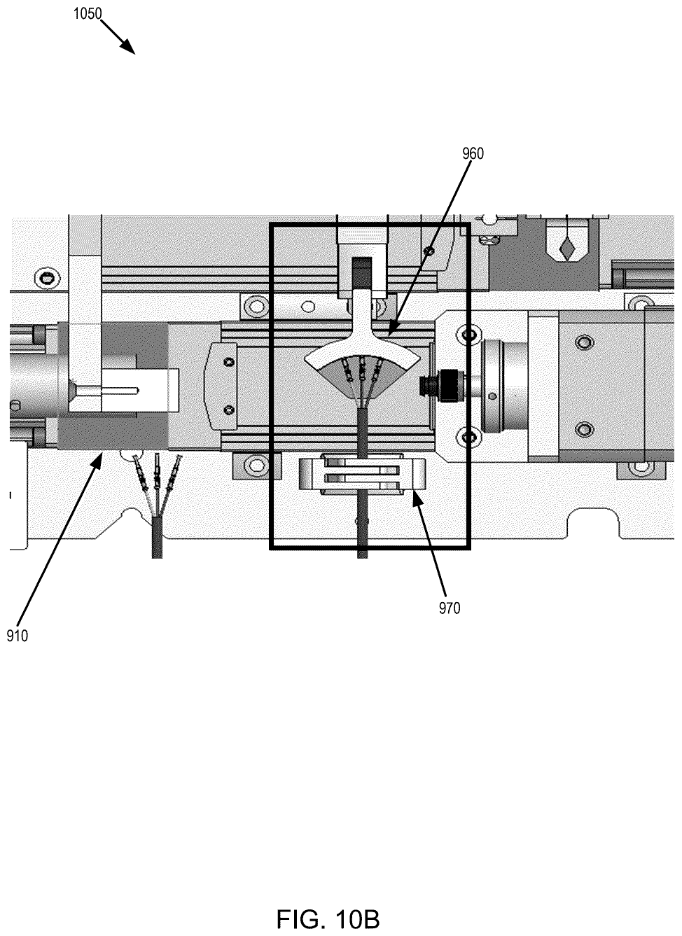

Prior to or after inserting the connector into the connector holder 950, an end of the cable may be pushed and/or pulled into the crimped-wires insertion to connector machine 710. In one or some embodiments, prior to pushing and/or pulling a respective end of the cable, the respective end of the cable, held by a clamp 990 (or the like), may first be released via applying a force, as shown by arrow 980, downward onto the clamp 990. In one or some embodiments, the force may be applied by a force applicator 1030, shown in FIG. 10A and which may comprise a robot or the like. After which, the respective end of the cable may be pushed and/or pulled into the crimped-wires insertion to connector machine 710. For example, in pulling the respective end of the cable, cable centering gripper 970, discussed with regard to FIGS. 10A-B, may be used to position or center the cable. Further, crimp contacts position gripper 960 may be used to hold the crimp contacts on the wires of the cable, as discussed further with regard to FIGS. 10A-B.

FIG. 10A is a top view 1000 of a pallet 1010 that holds both ends of the cable as the pallet 1010 enters the station for the crimped wire insertion machine illustrated in FIG. 9. In one or some embodiments, the pallet 1010, driven by a conveyor, may perform (or have performed on it) any one or both of: (i) enter the station; (ii) be moved relative to the station (e.g., any one, any combination, or all of be raised up; stepped aside; or moved inside the station).

As shown, the cable centering gripper 970 is configured to hold a part of the cable, such as on the insulation layer. In one or some embodiments, the cable centering gripper 970, after the pallet 1010 enters the station, may close on the cable and guide (e.g., pull) the respective end of the cable inside the station. For example, the cable centering gripper 970 may pull an end of the cable into the crimped wire insertion machine illustrated in FIG. 9. The movement of the cable, guided by the cable centering gripper 970, is illustrated by arrow 1020. As shown in the illustration 1050 in FIG. 10B, the cable is guided to be proximate to or to contact the crimp contacts position gripper 960. As shown in FIG. 10B, the cable has three wires. Various numbers of wires in the cable are contemplated, such as, for example, 1-20 wires. Though, greater numbers of wires are contemplated. Further, as shown in FIG. 10B, in one or some embodiments, the wires may be placed horizontally and facing forward, with no particular order of the wires.

In one or some embodiments, the crimp contacts position gripper 960 may be configured to hold one or more of the crimp contacts in a fixed or predetermined position. For example, the crimp contacts position gripper 960 may be configured to close and/or fix the crimp contacts.

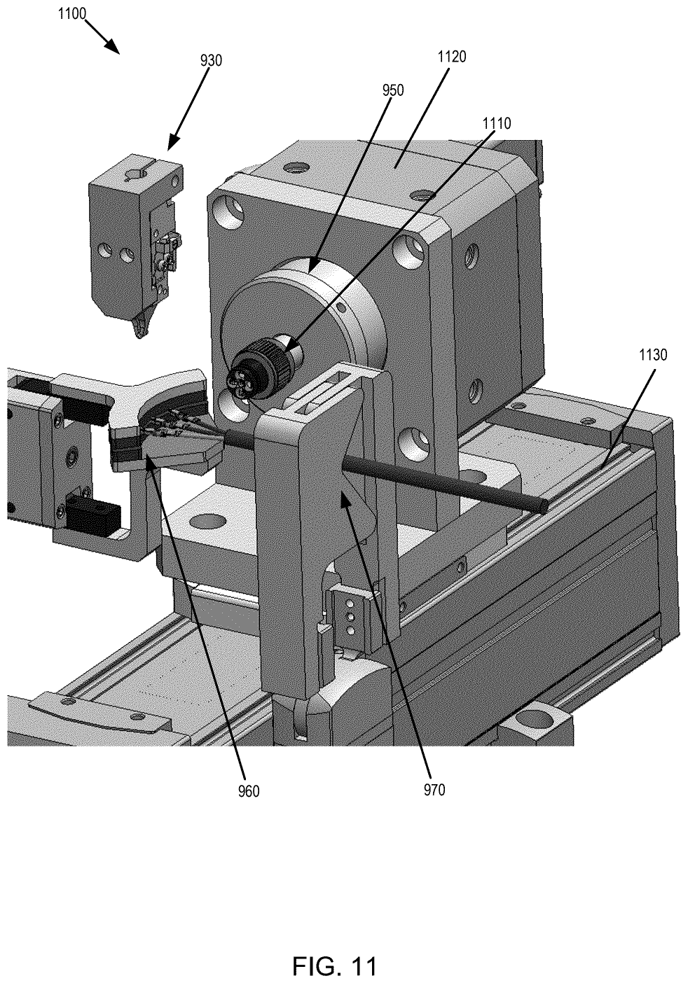

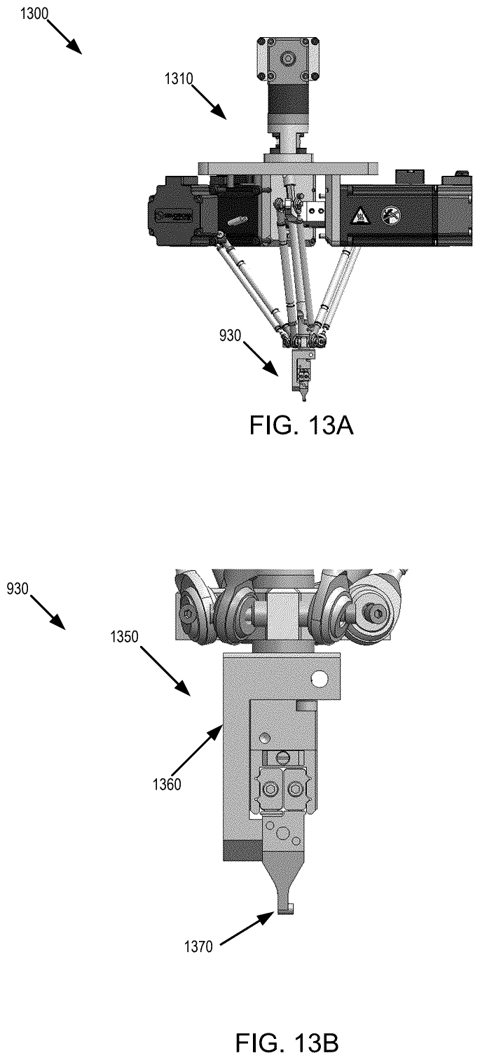

FIG. 11 is a side perspective view 1100 of the crimped wire insertion machine of FIG. 9, including hardware for wire and contact insertion steps. As discussed above, the crimp contacts position gripper 960 is configured to hold one or more of the crimp contacts. Prior to movement of the wire, the crimp contacts position gripper 960 may open or release one or more of the crimp contacts (such as release only the crimp contact for the desired wire that is to be next inserted into the connector). After which, in one or some embodiments, the wire gripper and robot 930 is configured to, responsive to a control command, to pick the desired wire. In one or some embodiments, the wire gripper and robot 930 may comprise a robot and a gripper, as discussed in more detail in FIGS. 13A-B. Further, in one or some embodiments, the gripper may select one or more parts of the wire, such as on the isolation of the wire or on the crimp contact. After gripping the wire, the gripper of the wire gripper and robot 930 is configured to take the crimp contact to the connector, and to have a side support positioned to contact the gripper, as discussed in more detail in FIGS. 16A-B. Further, the connector 1110 may be press fitted into the connector holder 950. In one or some embodiments, the connector presenter 940 may pick up the connector 1110 and insert the connector 1110 into the connector holder 950. In one or some embodiments, insertion of the connector 1110 into the connector holder 950 may result in the connector 1110 being positioned in a predetermined orientation (e.g., via using adapter 1550, discussed further below). Alternatively, after insertion of the connector 1110 into the connector holder 950, the connector holder 950 may be rotated a predetermined amount, such as by rotating connector holder 950, such as moving in a radial direction, using motor 1120 (e.g., a present orientation of the connector 1110 may be determined via camera 910; after which, the motor 1120 may be used to rotate the connector 1110 so that the connector 1110 is positioned in the predetermined orientation).

FIG. 12A is a side view of a part 1200 of the connector presenter slider and gripper and the side camera. As discussed above, one or more cameras may be used. As one example, the camera(s) may comprise side inspection camera(s) that are configured to obtain images regarding one or both of the wire gripper position or the angle position of the connector 1110. In particular, the camera 910 may obtain an image, prior to insertion of the crimp contact into the connector 1110, of the wire gripper and robot 930. The image may be sent to the processor in order to analyze the image to determine the position of the wire gripper and robot 930. Similarly, the camera 910 may obtain an image, prior to insertion of the crimp contact into the connector 1110, of the connector 1110. The image may be sent to the processor in order to analyze the image to determine the position or orientation of the connector 1110 (and in turn determine whether the connector 1110 is to have its orientation modified). As discussed further below, the orientation of the connector 1110 may be modified via one or more motors 1210 that may rotate connector holder 950, which while holding connector 1110, may rotate connector 1110. FIG. 12A further illustrates connector presenter slider and gripper 1220, discussed further below with regard to FIG. 14.

FIG. 12B is a camera view 1250 (from the perspective of the side camera 910 illustrated in FIG. 12A) of the connector presenter slider and gripper. As shown, camera 910 may obtain an image showing the orientation of the connector 1110 or the position of the wire gripper and robot 930.

FIG. 13A is a top view 1300 of the robot 1310 and wire gripper and robot 930. FIG. 13B is an expanded view of the top view illustrated in FIG. 13A of the wire gripper and robot 930. In one or some embodiments, the robot 1310 may comprise a delta robot that is configured to move in any one, any combination, or all of the following directions: X direction; Y direction; Z direction; or theta direction. Further, the wire gripper and robot 930 may comprise rotatable gripper.

As shown in FIG. 13B, wire gripper and robot 930 includes a housing 1350, which may provide support to one or more parts of the wire gripper and robot 930, such as providing side support 1360 and/or providing support for the finger(s) 1370 (alternatively termed tip) of the wire gripper and robot 930. As discussed further below, the side robot support 920 may contact side support 1360 to provide stability to wire gripper and robot 930. In one or some embodiments, a tip of the wire gripper and robot 930 may hold on one or both of the isolation of the wires or on an area connecting the wire to the crimp contact. In one or some embodiments, the gripping of the wire by the wire gripper and robot 930 does not create, or creates less than a predetermined amount of, tension on the copper or other conductive portion of the wire.

FIG. 14 is a side view 1400 of the connector presenter slider and gripper 1220. In one or some embodiments, the connector presenter slider and gripper 1220 comprises a long-travel pneumatic drive with rotatable gripper. As shown, one example of the rotatable gripper comprises the connector holder 950, which is held by support structure 1410 and is rotated by motor 1120. As such, connector presenter slider and gripper 1220 includes: a support structure 1410 configured to support one or both of the connector holder 950 and motor 1120; track structure 1420 that is configured to provide the mechanical support for support structure 1410 to move along track 1130 (shown in FIG. 11) that is on track structure 1420 (e.g., so that support structure 1410 may move laterally in one dimension), and motor 1430 configured to provide the motive support for support structure 1410 to move along track 1130. In one or some embodiments, the controller (which may comprise computing functionality such as illustrated in FIG. 27B) may be configured to determine how much to move support structure 1410 (such as how much to support structure 1410 so that connector held in connector holder 950 moves to finger(s) 1370 of wire gripper and robot 930, such as illustrated in FIG. 16A-B). Responsive to this determination, the controller may be configured to command motor 1430 to control the lateral movement of the support structure 1410 along track 1130 a predetermined amount.

FIGS. 15A-B are views 1500, 1530 of different parts of the connector presenter slider and gripper 1220 illustrated in FIG. 14, including a partial side view 1500 in FIG. 15A, an exploded view 1530 in FIG. 15B, and the connector holder 950 in FIG. 15C. In one or some embodiments, the connector presenter slider and gripper 1220 may comprise an electrically-driven slider and rotator, as discussed above. Further, in one or some embodiments, the setup may enable different connector holders 950, via one or more connection points 1542, to be inserted and therefore interchangeable in order to accommodate different types of connectors (e.g., a first connector holder for M8 male connector; a second connector holder for M8 female connector; etc.). For example, connector mounting block 1540 may be configured to have each of a plurality of different types of connector holders 950 be mounted thereon. The mounting of a respective connector holder 950 (e.g., via the connection points 1542) may be performed manually (e.g., by an operator inserting or attaching the respective connector holder 950 into the connector mounting block 1540). Alternatively, the mounting of a respective connector holder 950 may be performed automatically (e.g., by a robot inserting or attaching the respective connector holder 950 into the connector mounting block 1540). Further, the connector 1110 may be held within the connector holder 950 in one of several ways. In one way, the connector holder 950 may include a lip or adapter 1550 that may abut the connector. As one example, the adapter 1550 may mate with a part, such as an exterior housing, of the connector in order to situate or position the connector within connector holder 950 so that the connector is in the predetermined orientation. As such, the adapter 1550 may act as a socket for the connector 1110. In this regard, the adapter 1550 may, in the insertion of the connector 1110, rotate the connector 1110 in order to seat or position the connector 1110 within connector holder 950. As shown, in one or some embodiments, adapter 1550 may comprise a cylinder wall that is less than an entire circumference, such as less than 90% of the entire circumference, less than 80% of the entire circumference, less than 70% of the entire circumference, less than 60% of the entire circumference, or less than 50% of the entire circumference.

Before and/or after placement of the connector 1110 against adapter 1550, vacuum may be applied in order to hold the connector 1110 within connector holder 950. In this regard, the connector orientation may be positioned by adapter 1550 (thereby being coding dependent, such as dependent on the type of connector holder 950 in order to place the connector 1110 within the connector holder 950 forced into the predetermined orientation by adapter 1550).

FIGS. 16A-B are views 1600, 1650 illustrating the force controlled insertion of the crimp contact into the connector housing. In FIG. 16A, the wire gripper and robot 930 has gripped a respective wire (not shown) at its finger(s) 1370 and is holding the respective wire in a predetermined position relative to (such as in an X-direction away, as shown by 1630, from) a respective hole of connector 1110 held in connector holder 950. In preparation for the insertion, an amount of rotation of the connector holder is determined in order for the part of the crimp contact that is to contact with the electrical contact surface in the respective hole of the connector (see FIGS. 3A-D; 4A-B) are in the same orientation. For example, the electrical contact surface of the respective hole may currently be at 90° and the part of the crimp contact for contact is at 0°. In the example, the connector holder 950 may be rotated 90° counterclockwise so that the electrical contact surface of the respective hole may be at 0°, thereby matching with the orientation of the part of the crimp contact for contact. Also, in preparation for the insertion, side robot support 920 (an example of a side support device), which includes support structure 1610 (which may effectively comprise a thrust pad), is moved to contact a part of the wire gripper and robot 930, such as side support 1360 of wire gripper and robot 930. In this way, side robot support 920 may apply a force against wire gripper and robot 930) so that wire gripper and robot 930 remains stationary (or substantially stationary) as connector holder 950 is moved laterally toward (and contacts) finger(s) 1370 of wire gripper and robot 930 in order to insert connector 1110 held in connector holder 950 into the crimp contact held by finger(s) 1370 of wire gripper and robot 930. This is illustrated in FIG. 16B in which connector 1110 held by connector holder 950 is nearly contacting finger(s) 1370.

In this regard, in one or some embodiments, the wire gripper and robot 930 may not have the motive force to insert the crimp contact (held by the wire gripper and robot 930) into the connector 1110. In such an instance, the wire gripper and robot 930 may be stationary while the connector is moved to the crimp contact for insertion. As discussed above, to brace or provide support to the wire gripper and robot 930, the side robot support 920 may move (as shown by arrow 1620) so that structure 1610 abuts or contacts side support 1360. The actual contact of structure 1610 with side support 1360 is illustrated in FIG. 16B.

Thus, in one or some embodiments, the automatic insertion movement may be performed by moving one or both of the crimp contact of the respective wire or the connector relative to one another so that the crimp contact is inserted within a respective hole of the connector. Thus, in one embodiment, the crimp contact is stationary while the connector is moved toward the stationary crimp contact (such as laterally to the stationary crimp contact) so that the crimp contact (being stationary) is inserted into the hole of the moving connector. See FIGS. 16A-B. Alternatively, the connector is stationary as the crimp contact is moved toward the stationary connector so that the moving crimp contact is inserted into the hole of the stationary connector. Still alternatively, both the connector and the crimp contact may move, such as move in opposite directions, so that the moving crimp contact is inserted into the hole of the moving connector.

After the connector is moved to contact the stationary crimp contact (effectively inserting the crimp contact into the connector), the crimp contact via one or more tabs or the like, may be locked into the respective hole of the connector. After which, side robot support 920 may move, thereby moving support structure 1610 from contacting side support 1360. Before or after side robot support 920 moves, wire gripper and robot 930 may release the respective wire (since crimp contact is now locked within the respective hole). After releasing the respective wire, the connector holder 950 may be moved laterally back (via motor 1430 so that support structure 1410 moves away from stationary wire gripper and robot 930; see FIG. 16A). Still after which, wire gripper and robot 930 may select the next respective wire for performing the same procedure (e.g., wire gripper and robot 930 grips the next respective wire and moves the next respective wire into 3D space that is proximate to, but laterally away from connector holder 950; motor 1120 (either before or after wire gripper and robot 930 grips the next respective wire and/or moves the next respective wire into 3D space) rotates the connector holder 950 for the automatic orientation movement for the respective hole of the next respective wire; side robot support 920 may move support structure 1610 into contact with side support 1360; the connector holder 950 moves laterally so that the respective hole of the next respective wire moves to contact the crimp contact of the next respective wire).

FIG. 17 is an illustration 1700 showing different parts of the hardware which may be part of a crimped-wires insertion to connector machine. In particular, one or more cameras 1710 may be used, such as any one, any combination or all of top, side, or front cameras for detecting wire colors and/or detecting positioning of the wires within the comb and/or detecting positioning wires within the connector. Further, one or more robots. grippers or the like may be used to perform any one, any combination, or all of: removing the wire from the comb; directing the wire to the connector-specific hole; inserting the wire to the prescribed depth within the connector-specific hole; orienting the wire so that the wire and the hole match orientation for proper electrical connection; or bending the wire (e.g., by 90 degrees). As shown in FIG. 17, one machine, which may comprise a robot that may move in one, two, or three dimensions (such as XYZ robot 1712 that moves in the X, Y, and Z dimensions and which may perform any one, any combination, or all of: remove the wire from the comb; direct the wire to the connector-specific hole; insert the wire to the prescribed depth within the connector-specific hole; or bend the wire (e.g., by 90 degrees)). This is illustrated, for example, in FIGS. 19A-D. Further, as shown in FIG. 17, a second machine, such as a rotation position contact direction positioner 1714 may be configured to change the orientation of the wire end/crimp contact so that, when the XYZ robot inserts the wire end/crimp contact into the hole of the connector, the orientations match so that electrical connection between the wire end and the connector is achieved. This is illustrated, for example, in FIGS. 20A-D. FIG. 17 further illustrates support for connector holder 1716 (alternatively termed connector holder) and side comb 1718.

FIG. 18A is an illustration 1800 of a connector holder 1716 that is configured to hold a connector 1810. As discussed above, the connector 1810 may be placed within and/or supported by a connector holder 1716. As shown, the connector 1810 may be placed in various orientations to ease the insertion as needed. For example, FIG. 18B is an illustration 1830 of a connector orientation “key” 1832, which may be used for automatically positioning the connector, relative to the connector holder 1716, in a predetermined orientation. In particular, a robot. which may comprise XYZ robot 1712 or another robot, may place the connector 1810 into the connector holder 1716. In one embodiment, when slotted in, the connector orientation “key” 1832 may be used to orient the connector 1810 within the connector holder 1716. In one example, the connector orientation “key” 1832 may include one or more indicia to indicate the proper placement with the robot rotating the connector 1810 prior to inserting the connector 1810 within the connector orientation “key” 1832. Alternatively, or in addition, the camera(s) may analyze the connector 1810 to determine how to orient the connector (e.g., rotate the connector) prior to insertion within the connector holder 1716. Other ways in which to orient the connector 1810 within the connector holder 1716 are contemplated.

FIG. 18C is a top view 1850 of the connector holder 1716 illustrated in FIG. 18A with a 5 pin connector inserted therein and illustrating a rotatable support 1852 and one or more gripper height sensors 1854. FIG. 18D is top view 1870 of the connector holder 1817 illustrated in FIG. 18A with a 4pin connector inserted therein and illustrating the rotatable support 1852 and one or more gripper height sensors 1854. The rotatable support 1852 may be used to rotate the connector 1810 after being placed within the connector holder 1716. In one or some embodiments, the rotatable support 1852 may be used to rotate the connector 1810 in the event of difficulty in accessing a respective hole of the connector 1810. In this way, the rotatable support 1852 may enable an additional degree of freedom in positioning the connector 1810 relative to the gripper.

Further, connector holder 1717 may include one or more gripper height sensors 1854 (with two illustrated). As discussed in more detail below, one or more gripper height sensors 1854 may be used to provide sensor feedback on the placement of the wire within the respective hole of the connector 1810. In this way, the one or more gripper height sensors 1854 may provide feedback for closed loop pin insertion. This is illustrated further in FIG. 26B, discussed below.

FIG. 19A is an illustration 1900 of the wire move gripper device, with the delta 1910 (which may be an example of a robot or other motorized device configured to move the wire move gripper device), a sensor (which may comprise a force sensor 1912 configured to detect force during insertion of the wire/crimp contact into the connector in order to determine whether there are problems with insertion and/or to determine contact insertion verification (see FIG. 26C-D), and a gripper 1914. The XYZ robot 1712 is one example of the wire move gripper device. In particular, delta may be configured to move in one or more dimensions, such as in the X, Y, and Z directions. Further, one or more motors may be used to move the delta in the one or more directions. For example, in one embodiment, a single motor may be used to move in each of the respective directions. Alternatively, multiple motors may be used to move in the respective directions.

FIG. 19A further illustrates a force sensor 1912, which is configured to generate sensor data indicative of an amount of force that is being sensed by the gripper. The force sensor 1912 may be used in one or more respects, such as one or both of: sensing whether there is a problem with insertion (e.g., the wire is jammed, resulting in an excessive amount of force being sensed); or sensing whether the crimp contact is in contact with an interior bottom of the connector, thereby in the final proper seated position (as discussed further with regard to FIG. 26D).

FIG. 19A also illustrates rotation drive 1916 (alternatively termed rotation device) on the wire move gripper device. As discussed in more detail below, there may be instances where the wire is to be bent. For example, the wire may be bent 90 degrees prior to inserting the wire into the hole of the connector. The rotation drive 1916 may be configured to perform that. Finally, FIG. 19A illustrates the gripper 1914. FIGS. 19B-D are top 1930, side 1950, and perspective views 1970, respectively, of the gripper 1914 illustrated in FIG. 19A. As shown in FIG. 19B, gripper 1914, when its fingers 1934 are closed, includes a hole 1932 for the wire to be seated. As shown in FIG. 19D, the gripper 1914 includes slim gripper fingers configured to grip at least a part of the wire, such as the isolation layer of the wire.

FIG. 20A is an illustration 2000 of the orientation gripper device, which is an example of the rotation position and contact direction positioner 1714. As discussed above, the orientation of the wire end may need to be modified prior to insertion into a hole of the connector in order to match the orientation of the respective hole. See FIGS. 3A-B and 4A-B. In order to do this, an orientation gripper device may be used, which may include one or more motors 2010 that are configured to move the orientation gripper device in one or more dimensions, such as in any one, any combination, or all of the X, Y, and Z dimensions. The orientation gripper device further includes drive(s) 2012 configured to generate a rotational force via the gripper fingers 2016/gripper 2014 to rotate the wire end.

FIG. 20B is a perspective view 2030 of the gripper fingers 2016 of the gripper 2014 illustrated in FIG. 20A. In one embodiment, the gripper fingers 2016 may be composed of two separate sections, each of which include a wire tip holder 2032 and a loose contact straightener 2034. Any one, any combination, or all of the gripper fingers 2016, the wire tip holder 2032, or the loose contact straightener 2034, are example(s) of a crimp contact orientation modifier. The wire tip holder 2032 may be configured to contact the isolation layer of the wire, making contact on both sides of the isolation layer and gripping sufficiently strongly so that when the drive imparts the rotational force, the wire is moved axially so that the orientation of the wire may match the orientation of the hole of the connector. Alternatively, or in addition, each section of the gripper fingers may also include a loose contact straightener 2034. In practice, the crimp contact may be connected to the conductor, such as the copper, of the wire. Further, the crimp contact may be crimped onto the conductor. Because the conductor is not elastic, the crimp contact may move from the original crimped position. For example, the crimp contact may bend so that the wire and the crimp contact are not in line (e.g., the crimp contact is off axis of the wire, where the wire is the defined axis). In order to align the crimp contact so that it is on axis (or is more closely aligned with the wire), the loose contact straightener 2034 may be used. The loose contact straightener 2034 may include a plurality of teeth 2036 and may further be shaped such as to guide the crimp contact into axial alignment with the wire. For example, as shown in FIG. 20B, the loose contact straightener 2034 includes teeth 2036 on both sections of the gripper fingers 2016. When the gripper fingers 2016 are closed, a cavity therein is formed to guide the crimp contact into axial alignment.

FIG. 20C is a side view 2050 of part of the gripper fingers 2016 gripping onto a wire and the crimp contact, illustrating that the gripper fingers 2016 may perform one or both of straightening a loose crimp contact or gripping onto the insulation layer of the wire in order to impart a force onto the wire/crimp contact to rotate the wire to the desired orientation for insertion (see FIGS. 3A-B and 4A-B). FIG. 20D is a perspective view 2070 (with cutaway) illustrating the gripper fingers 2016 straightening the loose crimp contact (e.g., to be in axial alignment with the wire, which may or may not be housed within the teeth of the gripper fingers) and gripping onto the insulation layer of the wire in order to impart a force onto the wire/crimp contact to rotate the wire to the desired orientation for insertion (see FIGS. 3A-B and 4A-B).

FIGS. 21A-D are illustrations an example sequence of wire insertion with FIG. 21A showing a perspective view 2100 of the wires connected to or attached to a comb 2110. FIG. 21B showing a top view 2130 of FIG. 21A with comb holder 2132. FIG. 21C showing an isometric view 2150 of one wire/crimp contact having been inserted into a respective pin of the connector, and FIG. 21D showing a top view 2170 of FIG. 21C.

FIGS. 22A-B illustrate a top 2200 and a perspective view 2250 of the wire move gripper device 2210 taking a wire/crimp contact from the comb. In this way, the gripper 1914 of the wire move gripper device 2210 may take a respective wire from the comb 2110.

After the gripper 1914 of the wire move gripper device 2210 takes the respective wire from the comb 2110, the section at the end of the wire may be straight. This is shown in FIG. 23A. which illustrates a top view 2300 of the system after the wire move gripper device 2210 has taken the wire/crimp contact from the comb 2110 but prior to the wire move gripper device 2210 inserting the wire/crimp contact into a respective pin of the connector. FIG. 23A further illustrates orientation gripper device (e.g., see FIG. 20A) contacting the wire to re-orient the end of the wire. FIG. 23B illustrates an expanded view 2250 of the wire move gripper device 2210 and the orientation gripper device interacting with the wire/crimp contact. Thus, as the gripper 1914 of the wire move gripper device 2210 is holding the wire/crimp contact, the gripper fingers 2016 of the orientation gripper device may re-orient the wire/crimp contact.

In particular, the orientation gripper device may re-orient (e.g., rotate) the wire/crimp contact in preparation for the wire move gripper device 2210 to insert the wire/crimp contact into the respective pin of the connector. In practice, the orientation of the end of the wire may be misaligned (at least vis-à-vis with respect to the orientation of the respective hole of the connector). In particular, in one or some embodiments, the camera(s) may examine the end of the wire/crimp contact to determine its current orientation. The control system may then determine an amount of misalignment for this wire. By way of example, the control system may determine that this respective wire has a respective hole in which to be inserted in that has a horizonal orientation, such as illustrated by 310 in FIG. 3A. For example, the analysis may indicate that the end of the wire/crimp contact is 35 degrees out of alignment vis-à-vis with respect to the orientation (see 310) of the respective hole of the connector. In order to align the end of the wire to match the orientation (see 310) of the respective hole, the orientation gripper device may cause a 35 degree rotation of the end of the wire. In this way, when the wire move gripper device inserts the end of the wire into the respective hole, the end of the wire is properly oriented to the orientation (310) of the respective hole.

FIG. 24A illustrates a top view 2400 of the wire move gripper device inserting a first wire/crimp contact into a respective pin of an M12 5-pin connector (held within the connector holder). FIG. 24B illustrates a close up view 2420 of FIG. 24A of the gripper 1914 inserting the first wire/crimp contact into the respective pin of an M12 5-pin connector. FIGS. 24C-F illustrate close up views 2440, 2460, 2470, 2480 of the gripper 1914 inserting the second, third, fourth, and fifth wire/crimp contacts, respectively, into respective pins of an M12 5-pin connector.

As shown in FIGS. 24B-F, the wire move gripper device may follow a sequence in placing the wires in the respective holes of a connector. Various sequences of the order of wire placement are contemplated. In one or some embodiments, the order of wire placement may be dictated by spacing of the holes in a connector. In particular, in one embodiment, the sequence comprises first placing the wire in the hole that is furthest away from the gripper. This is illustrated in FIG. 24B in which the hole selected for the first insertion is on the left side while the gripper is oriented on the right side. The sequence, as illustrated in FIGS. 24C-F, shows that the wire move gripper device takes the wires one-at-a-time for insertion into holes left to right (e.g., the wire assigned to the most left hole (relative to the gripper) is put in first, and which holes moving rightward are inserted with wires, with eventually the last wire being placed on the right most hole).

FIG. 25A illustrates a top view 2500 of the wire move gripper device inserting a first wire/crimp contact into a respective pin of an M8 4-pin connector (held within the connector holder). FIG. 25B illustrates a perspective view 2520 of the wire move gripper device inserting the fourth wire/crimp contact into a pin of an M8 4-pin connector (without illustrating the connector holder and after the first, second and third wires/crimp contacts have been inserted into their respective pins of the connector). FIG. 25C illustrates a close up view 2530 of FIG. 25A of the gripper inserting the first wire/crimp contact into a pin of an M12 5-pin connector.

FIGS. 25D-F illustrate a close up views 2540, 2550, 2560 of the gripper 1914 inserting the second. third, fourth, and fifth wire/crimp contacts, respectively, into respective pins of an M12 5-pin connector. Similar to FIGS. 24A-F, the sequence of insertion of holes on the connector may be from further (or furthest) away from the gripper 1914 to nearer (or nearest) to the gripper.

As discussed above, different connectors and/or different holes within the same connector may have different depths. This may further complicate the automation of insertion of the wire end/crimp contact into the connector. Thus, in one or some embodiments, any one, any combination, or all of the following may be performed: (i) performing a partial insertion and thereafter a final insertion; (ii) using a first sensor (or a first set of sensors) for the determination or assistance in performing the partial insertion and thereafter using a second sensor (or a second set of sensors) for the determination or assistance in performing the final insertion; or (iii) using one or more sensors to determine whether the crimp contact is seated within or abutting against a wall or other structure within the connector.

One example of automatic insertion is shown in FIG. 26A, which illustrates a perspective view 2600 of the gripper 1914 inserting the wire/crimp contact into the connector and further illustrating the different devices, including sensor(s) on the connector holder, the force sensor 1912 on the wire move gripper device, and/or the position of the gripper 1914 (as determined by the wire move gripper device), that may be used for contact insertion verification.

FIG. 26B is a side view 2602 showing partial insertion (as shown by the gap 2610) by the gripper 1914 of the wire/crimp contact into the connector. In one or some embodiments, the insertion of the wire/crimp contact into a respective hole may be in a series of one or more stages, including a partial insertion stage (see FIG. 26B) and a final insertion stage (see FIG. 26D). The partial insertion stage may be ended responsive to sensor input, such as the gripper height sensors, such as force sensor 1912 (shown in FIGS. 19A-D and FIG. 26A) and resident on the connector holder. In practice, the wire move gripper device may insert the wire/crimp contact until the control system determines, based on the sensor data generated by the gripper height sensor(s) (e.g., force sensor 1912) that the gripper is proximate to the connector holder. After the control system makes that determination, in one embodiment, the control system may control the wire move gripper device to temporarily stop additional movement of the wire/crimp contact further into the hole of the connector. After which, the control system may command the wire move gripper device to further move the wire/crimp contact further into the hole of the connector, using one or more other inputs to determine when to stop further movement. For example, the control system may use one or more other sensors (e.g., the force sensor on the wire move gripper device) or the position (such as the absolute position) of the gripper (e.g., as determined by the delta) in determining that the crimp contact is in its final position (e.g., abutting an internal wall of the connector), in turn stopping further movement of the wire move gripper device.

Alternatively, the control system may transition from the partial insertion stage and to the final insertion stage without any temporary stoppage. In particular, the control system may control the wire move gripper device to continuously move until the crimp contact is in its final position. In practice, the control system may control the wire move gripper device to insert the wire/crimp contact until receiving the indication from the jaw sensor(s) of partial insertion. Immediately after which, the control system may receive input from other sensor(s) (e.g., the force sensor on the wire move gripper device) or the position (such as the absolute position) of the gripper (e.g., as determined by the delta) in determining that the crimp contact is in its final position.

FIG. 26C is a side view 2604 showing full insertion (as shown by no gap and where the gripper slides the wire/crimp contact until the crimp contact contacts the bottom edge of the connector). In particular, as shown in FIG. 26C, there is no gap between the gripper and the top of the connector at 2620. FIG. 26D is a cutaway view 2606 of FIG. 26C showing full insertion in which the crimp contact is fully inserted, having contacted the bottom edge of the connector. As shown in FIG. 26D, the wire 2630 has at one end a crimp contact. In the final press position, the end 2640 of the crimp contact abuts or is in contact with an inner wall 2650 of the hole of the connector. The sensor(s) (which may measure force that may indicate that a force, such as a force due to the inner wall 2650, is pushing against the crimp contact) and/or the position of the gripper 1914 (which may determine that the absolute position of the gripper 1914 indicates that the crimp contact is abutting the inner wall of the hole of the connector) may determine whether the wire/crimp contact is in the final press position.

FIG. 27A is a block diagram 2700 of parts of the system. A control system 2716 may communicate with one or more devices within the system, such as one or more robots 2710, the connector holder 2712, and one or more cameras 2714. As discussed above, one or more robots 2710 may be used. Merely by way of example, robot(s) 2710 may include one or both of the wire move gripper device (e.g., the XYZ robot) or the orientation gripper device (e.g., the rotation position and contact direction positioner). The control system 2716 may control the robot(s) 2710, such as based on data obtained from one or more sensors (e.g., the camera(s), the sensor(s) resident on the connector holder, or the like). In particular, the control system 2716 may determine, perform, or cause to perform any one, any combination, or all of steps listed in FIGS. 29-30.

FIG. 27B is a block diagram of the crimped-wires insertion to connector machine 710. As shown in FIG. 27B, the crimped-wires insertion to connector machine 710 may include a communication interface 2750, motor(s) 2752, illumination device 2754 (such as lamp(s) to illuminate parts of the system, such as the gripper, wires, etc.), hardware for cable manipulation 2756 (e.g., wire centering gripper), computational functionality 2760 (which may comprise at least one processor 2762 and at least one memory 2764), hardware for wire manipulation 2766 (e.g., wire gripper and robot, etc.), operating panel 2768 (e.g., a user interface, such as a touchscreen), and sensor(s) 2770 (e.g., camera(s) for machine vision). The communication interface 2750 is configured to communicate with one or more external devices, such as a central controller (see central controller 720) or other devices on the line (see Unit 1 . . . Unit N).

In all practical applications, the present technological advancement must be used in conjunction with a computer, programmed in accordance with the disclosures herein. For example, FIG. 28 is a block diagram of an exemplary computer system that may be utilized to implement the methods described herein, including implementing a control system, controllers, computational functionality (see computational functionality 2760). A central processing unit (CPU) 2802 is coupled to system bus 2804. The CPU 2802 may be any general-purpose CPU, although other types of architectures of CPU 2802 (or other components of exemplary computer system 2800) may be used as long as CPU 2802 (and other components of computer system 2800) supports the operations as described herein. Those of ordinary skill in the art will appreciate that, while only a single CPU 2802 is shown in FIG. 28, additional CPUs may be present. Moreover, the computer system 2800 may comprise a networked, multi-processor computer system that may include a hybrid parallel CPU/GPU system. The CPU 2802 may execute the various logical instructions according to various teachings disclosed herein. For example, the CPU 2802 may execute machine-level instructions for performing processing according to the operational flow described.

The computer system 2800 may also include computer components such as non-transitory, computer-readable media. Examples of computer-readable media include computer-readable non-transitory storage media. such as a random-access memory (RAM) 2806, which may be SRAM, DRAM, SDRAM, or the like. The computer system 2800 may also include additional non-transitory, computer-readable storage media such as a read-only memory (ROM) 2808, which may be PROM. EPROM. EEPROM, or the like. RAM 2806 and ROM 2808 hold user and system data and programs, as is known in the art. The computer system 2800 may also include an input/output (I/O) adapter 2810, a graphics processing unit (GPU) 2814, a communications adapter 2822, a user interface adapter 2824, a display driver 2816, and a display adapter 2818.

The I/O adapter 2810 may connect additional non-transitory, computer-readable media such as storage device(s) 2812, including, for example, a hard drive, a compact disc (CD) drive, a floppy disk drive, a tape drive, and the like to computer system 2800. The storage device(s) may be used when RAM 2806 is insufficient for the memory requirements associated with storing data for operations of the present techniques. The data storage of the computer system 2800 may be used for storing information and/or other data used or generated as disclosed herein. For example, storage device(s) 2812 may be used to store configuration information or additional plug-ins in accordance with the present techniques. Further, user interface adapter 2824 couples user input devices, such as a keyboard 2828, a pointing device 2826 and/or output devices to the computer system 2800. The display adapter 2818 is driven by the CPU 2802 to control the display on a display device 2820 to, for example, present information to the user such as subsurface images generated according to methods described herein.

The architecture of computer system 2800 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above). ASICs, and VLSI circuits. Input data to the computer system 2800 may include various plug-ins and library files. Input data may additionally include configuration information.

FIG. 29 is a first exemplary flow chart 2900. At 2910, the connector is inserted into the connector holder. This may be done automatically by a robot gripping a respective connector and inserting the respective connector into a holder, such as connector holder 950. At 2920, the orientation of the connector in the connector holder may be determined and/or confirmed. As discussed above, in one embodiment, the connector may be inserted within the connector holder, and because of an adaptor, be in a predetermined orientation. Alternatively, or in addition, the orientation of the connector may be determined and/or confirmed.

At 2930, a respective wire is selected for insertion of its crimp contact into the connector. As discussed above, various ways may be used to determine the order in which to select the respective wires, such as one or both of: (i) at least one aspect of the wire (e.g., color of the wire); or (ii) placement of the wire relative to other wires and/or relative to the connector (e.g., select the closest wire to the connector first). Either after or before 2930, at 2940, an automatic orientation movement is performed by moving one or both of the crimp contact of the respective wire or the connector in preparation for the automatic insertion movement. As one example, the connector may be rotated as the automatic orientation movement. Alternatively, or in addition, the respective wire and/or crimp contact may be re-oriented, such as by using the orientation gripper device (see FIGS. 20A-D). After performing 2940, at 2950, the automatic insertion movement is performed by moving one or both of the crimp contact of the respective wire or the connector relative to one another so that the crimp contact is inserted into the connector. As discussed above, one or both of at least a part of the wire (e.g., the crimp contact) or the connector may be moved in order to perform the insertion of the crimp contact into the connector. As one example, the connector may be moved with the crimp contact being stationary (e.g., see 16A-B). As another example, the crimp contact may be moved with the connector being stationary (e.g., see FIGS. 24A-F and FIGS. 25A-F). After which, at 2960, it is determined whether is to be placed in the connector. If so, flow chart 2900 loops back to 2930. If not, flow chart 2900 ends. After which, in one or some embodiments, a cover piece (such as an end cap) may be placed on connector.

FIG. 30 is a second exemplary flow chart 3000. Any one, any combination, or all of the steps listed in FIG. 30 may be performed or may be caused to be performed by the control system (or multiple control systems) as described herein. At 3002, the wire is selected for the gripper of the wire move gripper device (e.g., the XYZ robot) to grip. As discussed above, various ways may be used to determine which wire to select (e.g., camera used to determine the colors of the wires in the event that the wires are placed randomly on the comb; look-up table in the event that the wires are placed in predetermined positions on the comb).

At 3004, the wire move gripper device (e.g., the XYZ robot) is moved to position the gripper of the XYZ robot to grip. At 3006, the gripper of the XYZ robot is opened. At 3008, the gripper of the XYZ robot is closed on the selected wire. At 3010, the end of the selected wire is examined to determine the current orientation and to determine how much rotation is needed to match orientation of the respective hole of the connector in which the wire is to be inserted.

At 3012, move one or both of the XYZ robot or the orientation gripper robot so that the selected wire (still currently held by the gripper of the XYZ robot) and the gripper of the orientation gripper robot face one another. At 3014, the gripper of the orientation gripper robot opens. At 3016, move one or both of the XYZ robot or the orientation gripper robot so that wire/crimp contact is contained within gripper of orientation gripper robot. After which, at 3018, close gripper of the orientation gripper robot, thereby the crimp contact/isolation of the wire is contained within or held by the gripper of the orientation gripper robot. In particular, the isolation of the wire is held by the gripper while the crimp contact is straightened.

At 3020, the gripper of the orientation gripper robot rotates the amount of rotation needed to insert into hole of connector (e.g., the match the orientation of the wire with the orientation of the hole of the connector). In one or some embodiments, the rotational force is imparted by the gripper of the orientation gripper robot onto the isolation of the wire (and not on the crimp contact). Though not depicted in FIG. 30, prior to the gripper on the orientation gripper robot rotating the wire, the gripper of the XYZ robot is released. Further, after the gripper on the orientation gripper robot has rotated the wire, the gripper of the XYZ robot is reengaged.

At 3022, the wire is bent (e.g., 90 degrees) using the gripper of the XYZ robot. At 3024, use the XYZ robot to move the wire to be positioned above the selected hole in the connector (which is housed in the connector holder).

At 3026, move the gripper of the XYZ robot (e.g., downward) in order to insert the wire (and the crimp contact) into the selected hole of the connector until the sensor on the connector holder indicates partial insertion. At 3028, continue moving the gripper of the XYZ robot (e.g., downward) until it is determined (e.g., by force sensor on XYZ robot or by the determined position of the gripper) that the crimp contact is seated on the contact edge or contact wall within the connector.

Steps 3002 to 3028 may be performed for each wire on the comb that needs to be inserted into a respective hole in the connector. As such, at 3030, it is determined whether there are additional wires to place in the connector. If so, flow chart 3000 loops back to 3002. If not, flow chart 3000 ends.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

1. A method for automatically inserting crimp contacts of a plurality of wires into holes of a connector, the connector having within a plurality of electrical contact surfaces for electrical contact with the crimp contacts of the plurality of wires, the method comprising:
for at least two of the plurality of wires, sequentially selecting a respective wire so that a designated part of the crimp contact of the respective wire physically contacts the electrical contact of a respective hole of the connector by:
prior to performing an automatic insertion movement of one or both the crimp contact of the respective wire or the connector, performing an automatic orientation movement by moving one or both of the crimp contact of the respective wire or the connector in preparation the automatic insertion movement; and
after automatically performing the orientation movement, performing the automatic insertion movement of one or both the crimp contact of the respective wire or the connector by moving one or both of the crimp contact of the respective wire or the connector so that the designated part of the crimp contact physically contacts the electrical contact surface of respective hole of the connector; and
wherein the automatic orientation movement results in orientation of the designated part of the crimp contact and orientation of the electrical contact of a respective hole being the same so that the insertion movement, resulting in the physical contact of the designated part of the crimp contact with the electrical contact surface of the respective hole of the connector, consists of a lateral movement without any axial movement.

2. (canceled)

3. A method for automatically inserting crimp contacts of a plurality of wires into holes of a connector, the connector having within a plurality of electrical contact surfaces for electrical contact with the crimp contacts of the plurality of wires, the method comprising;
prior to selecting a respective wire, spreading the plurality of wires;
for at least two of the plurality of wires, sequentially selecting the respective wire so that a designated part of the crimp contact of the respective wire physically contacts the electrical contact of a respective hole of the connector by:
prior to performing an automatic insertion movement of one or both the crimp contact of the respective wire or the connector, performing an automatic orientation movement by moving one or both of the crimp contact of the respective wire or the connector in preparation the automatic insertion movement; and
after automatically performing the orientation movement, performing the automatic insertion movement of one or both the crimp contact of the respective wire or the connector by moving one or both of the crimp contact of the respective wire or the connector so that the designated part of the crimp contact physically contacts the electrical contact surface of respective hole of the connector.

4. The method of claim 3, wherein spreading the plurality of wires results from crimping each of the plurality of wires with the crimp contacts and after crimping the plurality of wires, placing a crimped end of each of the plurality of wires in a predetermined place and in a predetermined orientation so that the plurality of wires are spread.

5. The method of claim 4, wherein the predetermined place comprises a comb so that the each of the plurality of wires is positioned on the comb; and
wherein inserting the end of the respective wire comprises using a gripper to grip the respective wire from the comb and moving the end of the respective wire into the connector.

6. The method of claim 4, wherein the predetermined place comprises a flat surface; and
wherein inserting the end of the respective wire comprises using a gripper to grip the respective wire from the flat surface and moving the end of the respective wire into the connector.

7. A method for automatically inserting crimp contacts of a plurality of wires into holes of a connector, the connector having within a plurality of electrical contact surfaces for electrical contact with the crimp contacts of the plurality of wires, the method comprising;
for at least two of the plurality of wires, sequentially selecting a respective wire so that a designated part of the crimp contact of the respective wire physically contacts the electrical contact of a respective hole of the connector by:
prior to performing an automatic insertion movement of one or both the crimp contact of the respective wire or the connector, performing an automatic orientation movement by moving one or both of the crimp contact of the respective wire or the connector in preparation the automatic insertion movement; and
after automatically performing the orientation movement, performing the automatic insertion movement of one or both the crimp contact of the respective wire or the connector by moving one or both of the crimp contact of the respective wire or the connector so that the designated part of the crimp contact physically contacts the electrical contact surface of respective hole of the connector; and
wherein the plurality of electrical contact surfaces in the connector face different directions; and
wherein, for the respective wire, one or both of moving the connector or moving the crimp contact of the respective wire results in movement of one or both of: (i) a part of the crimp contact of the respective wire that is for physical contact with the electrical contact surface; or (ii) the electrical contact surface, so that the part of the crimp contact and the electrical contact surface are in alignment prior to insertion.

8. The method of claim 7, wherein after spreading the plurality of wires, only rotating the connector is performed in order for the part of the crimp contact and the electrical contact surface to be in alignment prior to insertion.

9. The method of claim 8, wherein the connector is held in a connector holder; and
wherein the connector holder rotates, while holding the connector, in order for the connector to rotate in order for the part of the crimp contact and the electrical contact surface to be in alignment prior to insertion.

10. The method of claim 7, wherein after spreading the plurality of wires, only rotating the part of the crimp contact is performed in order for the part of the crimp contact and the electrical contact surface to be in alignment prior to insertion.

11. The method of claim 10, wherein, after gripping the respective wire with a gripper, the part of the crimp contact is rotated while the gripper is gripping the respective wire in order for the part of the crimp contact and the electrical contact surface to be in alignment prior to insertion; and
after rotation of the part of the crimp contact, the gripper inserts the crimp contact into a respective hole of the connector.

12. The method of claim 11, wherein the gripper grips an isolation layer of the respective wire; and
while the gripper is gripping the isolation layer of the respective wire, a crimp contact orientation modifier is gripping at least a part of the crimp contact in order to rotate the crimp contact so that the part of the crimp contact and the electrical contact surface to be in alignment prior to insertion.

13. (canceled)

14. The method of claim 1, wherein the automatic insertion movement comprises maintaining the crimp contact stationary as the connector is moved;
wherein at least a part of the respective wire is held by a gripper as the crimp contact is stationary; and
wherein, prior to movement of the connector toward the crimp contact that is stationary, a support structure is moved to contact at least a part of the gripper in order to brace the gripper in preparation for the connector moving to the crimp contact so that the part of the crimp contact is inserted within a respective hole of the connector.

15. A system for automatically inserting crimp contacts of a plurality of wires into holes of a connector, the connector having within a plurality of electrical contact surfaces for electrical contact with the crimp contacts of the plurality of wires, the system comprising:
a controller;
an automatic orientation movement device in communication with the controller and configured to perform an automatic orientation movement by moving one or both of the crimp contact of the respective wire or the connector in preparation for an automatic insertion movement; and
an automatic insertion movement device in communication with the controller and configured to perform the automatic insertion movement of one or both the crimp contact of the respective wire or the connector by moving one or both of the crimp contact of the respective wire or the connector so that a designated part of the crimp contact physically contacts the electrical contact surface of respective hole of the connector;
wherein the automatic orientation movement device is configured to perform the automatic orientation movement so that orientation of the designated part of the crimp contact and orientation of the electrical contact of a respective hole are the same so that the insertion movement, resulting in the physical contact of the designated part of the crimp contact with the electrical contact surface of the respective hole of the connector, consists of a lateral movement without any axial movement.

16. (canceled)

17. The system of claim 15, wherein the automatic orientation movement device comprises a gripper and at least one motor;
wherein the gripper is configured to grip part or all of the crimp contact; and
wherein the at least one motor is configured to rotate the gripper in order to modify orientation of the crimp contact.

18. The system of claim 17, wherein the gripper comprises gripper fingers that include a contact straightener that has a plurality of teeth in order to guide the crimp contact to the modified orientation.

19. The system of claim 15, wherein the automatic orientation movement device comprises a connector holder and at least one motor;
wherein the connector holder is configured to hold the connector; and
wherein the at least one motor is configured to rotate the connector holder, while the connector holder is holding the connector, in order to modify orientation of the connector.

20. The system of claim 19, wherein the automatic orientation movement device further comprises a mounting block configured to mount to a plurality of different connector holders;
wherein the plurality of different connector holders are for holding different types of connectors.

21. (canceled)

22. The system of claim 15, wherein the automatic insertion movement device is configured to move the connector as the crimp contact is stationary;
wherein the automatic insertion movement device comprises at least one motor and a track device configured to move a support structure laterally via a track using the at least one motor;
wherein the support structure is connected to a connector holder;
wherein the connector holder is configured to hold the connector; and
wherein the automatic insertion movement device is configured to move the support structure laterally via the track so that the connector, held in the connector holder is moved to the crimp contact.

23. The system of claim 22, wherein the automatic insertion movement device further comprises a gripper configured to grip the respective wire and hold the wire stationary as the connector holder moves laterally so that the connector contacts the crimp contact.

24. The system of claim 23, wherein the automatic insertion movement device further comprises a side support device configured to move a side support into contact with the gripper so that the side support is configured to apply a force to at least a part of the gripper as the connector holder is moved so that the connector contacts the crimp contact.

25. (canceled)

26. The system of claim 15, wherein the automatic orientation movement device and the automatic insertion movement device include one or more common parts;
wherein both the automatic orientation movement device and the automatic insertion movement device include a single connector holder;
wherein the single connector holder is configured to hold the connector;
wherein the single connector holder is configured to move radially in order to perform the automatic orientation movement; and
wherein the single connector holder is configured to move laterally in order to perform the automatic insertion movement.

27. The system of claim 26, wherein at least a first motor is configured to move the single connector holder radially; and
wherein at least a second motor is configured to move the single connector holder laterally.

28. (canceled)

29. (canceled)

30. (canceled)

31. (canceled)

32. The system of claim 15, wherein the controller is configured to select a sequence perform wire-by-wire automatic orientation movement and automatic insertion movement based on one or both of at least one aspect of the plurality of wires or positioning of the plurality of wires relative to one another or the connector;
wherein the at least one aspect of the plurality of wires comprises color of insulation layer of the plurality of wires.

33. The system of claim 32, wherein the controller is further configured to determine, based on at least one image, the positioning of wires relative to one another or the connector; and
wherein the controller is configured to determine the sequence based on the positioning and based on the color of the insulation layer.

34. The system of claim 33, wherein the controller is configured to select at least one wire based on the positioning and at least one wire based on the color of the insulation layer.

35. A system for automatically inserting crimp contacts of a plurality of wires into holes of a connector, the connector having within a plurality of electrical contact surfaces for electrical contact with the crimp contacts of the plurality of wires, the system comprising:
an automatic orientation movement device;
an automatic insertion movement device;
a controller in communication with the automatic orientation movement device and the automatic insertion movement device, the controller configured to:
prior to selecting a respective wire, control spreading the plurality of wires;
for at least two of the plurality of wires, control sequentially selecting the respective wire so that a designated part of the crimp contact of the respective wire physically contacts the electrical contact of a respective hole of the connector by:
prior to performing an automatic insertion movement of one or both the crimp contact of the respective wire or the connector, control the automatic orientation movement to perform an automatic orientation movement device by moving one or both of the crimp contact of the respective wire or the connector in preparation the automatic insertion movement; and
after automatically performing the orientation movement, control the automatic insertion movement device to perform the automatic insertion movement of one or both the crimp contact of the respective wire or the connector by moving one or both of the crimp contact of the respective wire or the connector so that the designated part of the crimp contact physically contacts the electrical contact surface of respective hole of the connector.
